(19) United States
(12) Patent Application Publication
(10) Pub. No.: US 2015/0098309 A1
(43) Pub. Date: Apr. 9, 2015

(54) MULTI-MEDIA WIRELESS WATCH

(71) Applicant: I.AM.PLUS, LLC, Los Angeles, CA (US)

(72) Inventors: William Adams, Los Angeles, CA (US); Chandrasekar Rathakrishnan, Singapore (SG); Jaren Chee Wei Goh, Singapore (SG)

(21) Appl. No.: 14/514,377

(22) Filed: Oct. 14, 2014

Related U.S. Application Data
(63) Continuation-in-part of application No. 14/460,300, filed on Aug. 14, 2014.
(60) Provisional application No. 61/866,372, filed on Aug. 15, 2013.

(51) Int. Cl. G04G 21/08; G04G 9/00

(52) U.S. Cl. CPC G04G 21/08; G04G 9/00
USPC 368/10

(57) ABSTRACT

A method for controlling a smart watch with a touch-sensitive display comprises detecting contact with the touch-sensitive display while the smart watch is displaying a first application interface associated with a first application. The detected contact can originate in a first area of the touch-sensitive display and move in a first direction. The method can further comprise displaying a first menu of first application interfaces available within the first application. The first application interfaces can comprise a set of unique user interfaces that are accessible within the first application. Additionally, the method can comprise detecting contact on an indication of a particular first application interface from within the first menu. The method can also comprise displaying, on the touch sensitive display, the particular first application interface.

### CROSS-REFERENCE TO RELATED APPLICATIONS

This application is a continuation-in-part of U.S. patent application Ser. No. 14/460,300 filed on Aug. 14, 2014, entitled “MULTI-MEDIA WIRELESS WATCH,” which claims priority to and the benefit of U.S. Provisional Application No. 61/866,372, filed on Aug. 15, 2013, entitled “Multi-media Wireless Watch.” All the aforementioned applications are incorporated by reference herein in their entirety.

### BACKGROUND OF THE INVENTION

1. Technical Field

Implementations of the present invention include wristwatches and bangle ornaments that comprise computing functionality.

2. Background and Relevant Art

In an increasing quantized and connected world, innovators and consumers are seeking way of integrating technology more seamlessly into their daily lives. Modern smart phones have been one method by which consumers have increasingly integrated connectivity into their daily lives. For example, many smart phone users frequently user their phones to take and upload pictures, text friends, call friends, navigate streets, identify new restaurants, and perform other such activities.

An additional recent movement in integrating technology into consumer's lives has involved so called “smart watches.” Conventional smart watches vary dramatically in functionality and form. In general, many conventional smart watches include some form of rudimentary health tracking utilities. For example, many conventional smart watches include pedometers, which can be used to track the number of steps the user took. Similarly, many conventional smart watches include gyroscopes that can be used to detect movement during sleep.

In addition to providing health tracking, some conventional smart watches also provide limited forms of connectivity. In particular, conventional smart watches can communicate with a smart phone that is also owned by the smart watch user. For example, the conventional smart watch may be able to receive information from the smart phone through BLUETOOTH. For instance, a convention smart watch may display a notification that the smart phone has received a text message. The notification may comprise brief information about the text message.

Conventional smart watches, however, suffer from several shortcomings. In particular, one will understand, that fitting the necessary components into a small form factor like a smart watch is an onerous task. In particular, because most consumers desire watches that are fashionable and attractive, there is a need for a smart watch that comprises a pleasing form-factor, while at the same time comprising a form-factor that allows the smart watch to function.

Additionally, conventional smart watches suffer from shortcomings in interface. One will understand that, in general, a smart watch will comprise less useable surface area for a user interface than a smart phone. Many conventional smart watches have failed to provide user interfaces that are both intuitive and visually useful. For example, the conventional smart phone user interface comprises a grid-like display of mobile applications. For several reasons, one will understand that displaying a large grid of several applications on a small smart watch display may provide a clumsy and inefficient user interface.

Accordingly, there are several problems within the field of conventional smart watches that can be addressed.

### BRIEF SUMMARY OF THE INVENTION

Implementations of the present invention comprise systems, methods, and apparatus configured to provide users with an attractive and useful arm-wearable computer accessory. In particular, implementations of the present invention comprise wrist accessories that include integrated cellular phone capabilities, personal multimedia functionality, web-connectivity, and other similar features. Additionally, implementations of the present invention provide novel form factors and methods of interface and information display that address several shortcomings in the conventional art.

For example, implementations of the present invention comprise a method for controlling a smart watch. A method for controlling a smart watch with a touch-sensitive display comprises detecting contact with the touch-sensitive display while the smart watch is displaying a first application interface associated with a first application. The detected contact can originate in a first area of the touch-sensitive display and move in a first direction. The method can further comprise displaying a first menu of first application interfaces available within the first application. The first application interfaces can comprise a set of unique user interfaces that are accessible within the first application. Additionally, the method can comprise detecting contact on an indication of a particular first application interface from within the first menu. The method can also comprise displaying, on the touch sensitive display, the particular first application interface.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an implementation of a smart watch;

FIG. 2 illustrates another view of the smart watch of FIG. 1;

FIG. 3A illustrates a cross section of an implementation of the smart watch of FIG. 1;

FIG. 3B illustrates a cross section of another implementation of the smart watch of FIG. 1;

FIG. 4 illustrates an implementation of a user interacting with a user interface of a smart watch;

FIG. 5 illustrates an implementation of the user interface of FIG. 4;

FIG. 6 depicts an implementation of a user interface of a smart watch;

FIG. 7 depicts another implementation of a user interface of a smart watch;

FIG. 8 depicts yet another implementation of a user interface of a smart watch;

FIG. 9 depicts still another implementation of a user interface of a smart watch;

FIG. 10 depicts another implementation of a user interface of a smart watch;

FIG. 11 depicts yet another implementation of a user interface of a smart watch;

FIG. 12 depicts still another implementation of a user interface of a smart watch;

FIG. 13 depicts a flow chart of an implementations of a user interface of a smart watch;

FIGS. 14A-14I depict various user interfaces within a phone application for a smart watch;

FIGS. 15A-15I depict various user interfaces within a contacts application for a smart watch;

FIGS. 16A-16H depict various user interfaces within a messaging application for a smart watch;

FIGS. 17A-17M depict various user interfaces within an email application for a smart watch;

FIGS. 18A-18I depict various user interfaces within a music application for a smart watch;

FIGS. 19A-19F depict various user interfaces within a calendar application for a smart watch;

FIGS. 20A-20J depict various user interfaces within a clock application for a smart watch;

FIGS. 21A-21J depict various user interfaces within a gallery application for a smart watch;

FIGS. 22A-22S depict various user interfaces within a settings application for a smart watch; and

FIG. 23 depicts a flow chart for a method in accordance with an embodiment of the present invention.

### DETAILED DESCRIPTION OF THE PREFERRED EMBODIMENTS

The present invention extends to systems, methods, and apparatus configured to provide users with an attractive and useful arm-wearable computer accessory. In particular, implementations of the present invention comprise wrist accessories that include integrated cellular phone capabilities, personal multimedia functionality, web-connectivity, and other similar features. Additionally, implementations of the present invention provide novel form factors and methods of interface and information display that address several shortcomings in the conventional art.

Accordingly, in at least one implementation of the present invention, a fashionable and functional smart watch is provided. Embodiments can include a wearable computing device in the form of a wristwatch/bangle or ornament. As used herein, a smart watch can comprise a bangle-shaped, wrist mounted computing device, a computing device shaped like a conventional watch, or any number of other wrist mounted computing devices. In some embodiments, such wearable computing devices can include various multimedia and/or wireless functions. As such, embodiments herein can include a wearable smart watch 100.

Smart watches can include any combination of hardware and software that enable functionality such as telephony, electronic communications, intelligence (including contextual intelligence) including pushing and pulling relevant information, voice control, home automation, fitness tracking/coaching/calories burn, social interaction, offline and online media playback, extendibility (e.g., “apps”), interoperability (e.g., interfacing with other devices), etc.

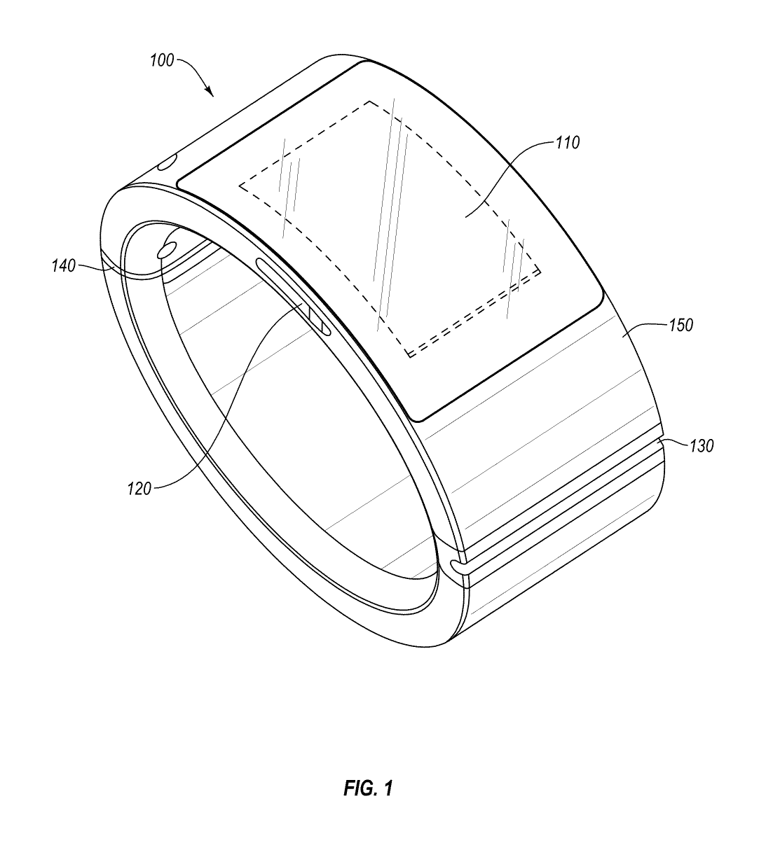

FIGS. 1 and 2 illustrate different views of an example of a smart watch 100 according to one or more embodiments of the present invention. As depicted, the smart watch 100 includes a display 110. For example, the smart watch 100 can include a display 110 based on any appropriate technology (e.g., LED, OLED, plasma, e-ink/e-paper, etc.). In some embodiments, the display 110 includes a touch digitizer (e.g., resistive, capacitive, etc.) to thereby create a touch-sensitive display (e.g., single- or multi-touch). In some embodiments, the display 110 is flexible. For example, the display may include a flexible display member comprising plastic, resin, polycarbonate, film etc., or may include a flexible glass display member (e.g., Corning® Willow™ Glass or film based OLED technology).

Additionally, the smart watch 100 includes a band 150. The band 150 may be comprised of a rigid material, a flexible material, or combinations thereof, and may include any material that is known in the art of watch making, as well as any other materials that can be used to form a rigid or a flexible band. In particular, the band 150 can comprise a ceramic material. Additionally, as depicted the band 150 can comprise a bangle shape. When describing the smart watch 100, the display 110 can be described as embedded within the band 150, or the band 150 can be described as attaching to respective ends of the display 110. Additionally, the band 150 can include one or more latches 140 and one or more hinges 130. Any latches 140 may employ any combination of fasteners, including mechanical and magnetic.

Additionally, in at least one implementation, the latch can be configured to received an extender, which extender comprises the same connector interface as the latch 140. As such, in at least one implementation, adding an extender at the latch 140 can enlarge the size of the band 150. The extenders can comprise various different sizes and shapes to fit the needs of a given user.

As depicted, the smart watch 100 may include one or more physical buttons 200. Any included buttons 200 may be usable to control an operating system and/or hardware devices of the smart watch 100. In at least one implementation, the smart watch 100 may include one or more additional output devices, such as one or more speakers, one or more lights, one or more headphone jacks, one or more haptic output devices (e.g., vibration units), etc. For example, in at least one implementation, a speaker may be positioned below the watch screen. Additionally, the watch may comprise noise cancellation technology and/or an audio insulator to prevent interference between the speaker and a microphone that may also be incorporated into the watch.

Additionally, the smart watch 100 may also include a port 210. The port 210 may comprise one or more electronic connectors, and may be configured to provide power to the smart watch 100 (e.g., to charge any included battery or batteries) and/or to facilitate one- or two-way data transfer between the smart watch 100 and an external computing device (e.g., a general-purpose personal computer, an accessory device, etc.). The port 210 can comprise any appropriate data port type, such as a serial (e.g., USB, SPI) port.

One will understand that properly fitting the desired electronics into a form factor the size of a smart watch 100 can be a technically challenging process. This is particularly true when attempting to create a visually attractive product. Accordingly, one will appreciate that the technical and design decisions involved in achieving a particular form factor of a smart watch 100 and the technical and design decisions involved in the placement of components within a smart watch 100 can involve significant novelty and inventiveness.

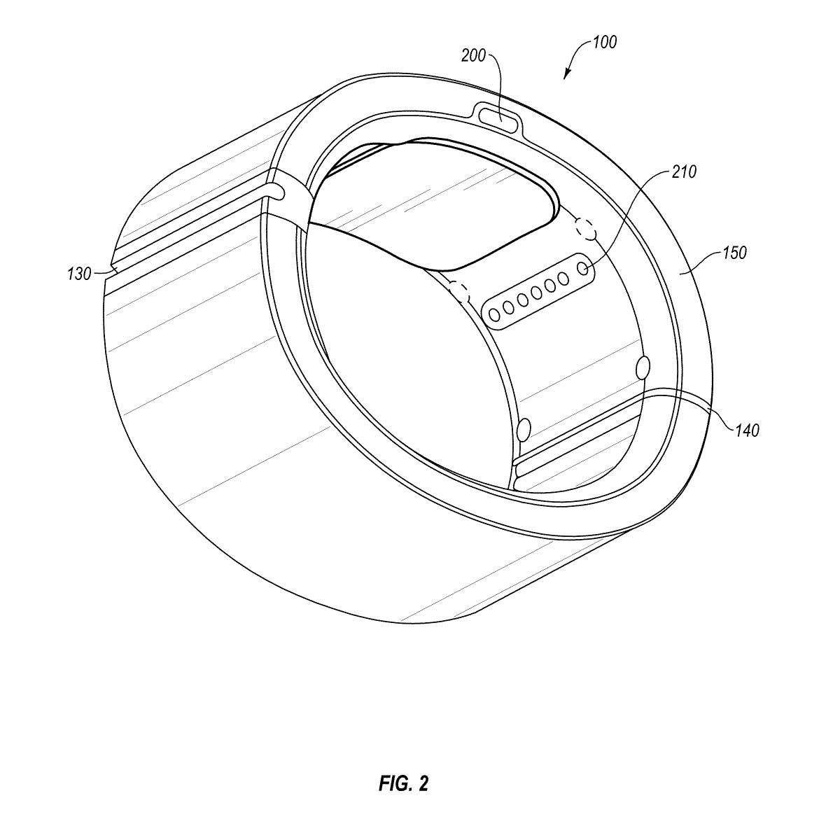

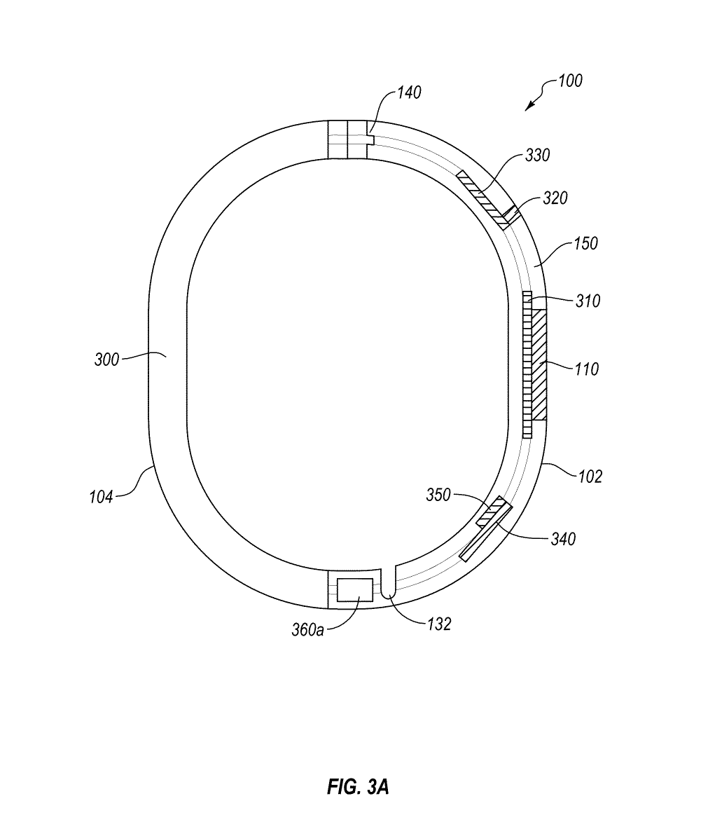

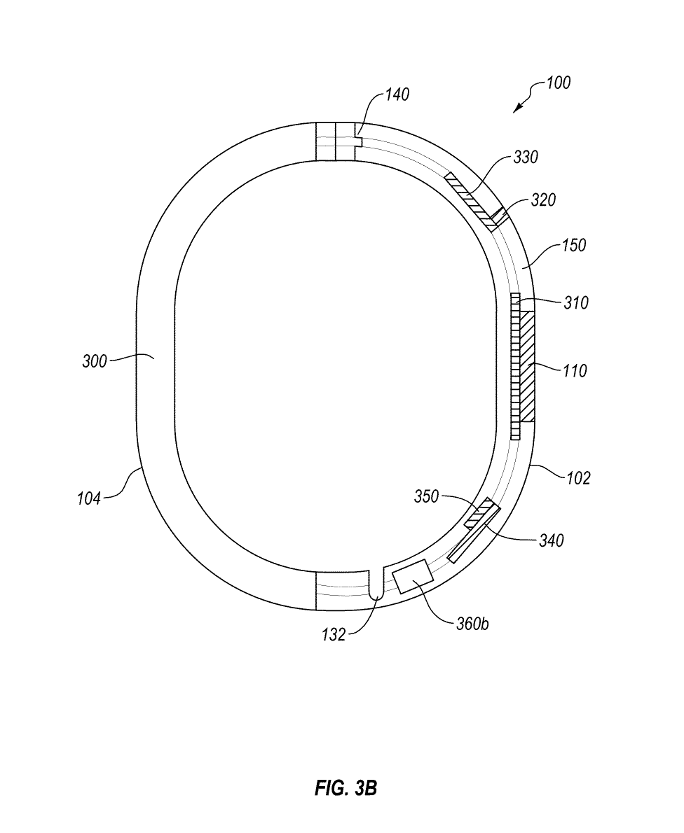

For example, FIG. 3A depicts a cross-sectional view of the smart watch 100 of FIGS. 1 and 2. The depicted cross-section also exposes various internal components of the smart watch 100. In some embodiments, the band 150 includes one or more batteries 300 that are disposed therein. For example, the band 150 may include one or more flexible battery cells, and/or one or more rigid battery cells. When using rigid battery cells, the band 150 may include a plurality of linked (e.g., in series) battery cells that are positioned within the band 150 in a manner that permits some flexibility of the band 150. One will understand that the battery life is a significant concern when designing and using a smart watch 100. As such, the particular placement of a battery 300 within the band 150 may significantly influence the battery size, battery configuration, and overall aesthetic look and function of the device. Accordingly, the particulars relating to placement and configuration of the battery 300 within the band 150 addresses significant needs within the field.

In some embodiments, one or both of the display 110 or the band 150 may include one or more solar cells (not shown). The solar cells may be used to charge any batteries 300 disposed within the smart watch 100 or to supply power to computing hardware, the display 101, and/or any electronic lights, sensors, input devices, output devices, communications devices, or other electric components disposed within the smart watch 100.

FIGS. 3A and 3B depict various additional internal components of a smart watch 100. For example, a smart watch 100 can comprise a processing unit 310, a visual processing unit 330, a biometric unit 340, and various antennas 360(a-b). The processing unit 310 can comprise a general-purpose computer processor, a system-on-a-chip solution, or any other available processing hardware. In at least one implementation, the display 110 is in physical communication with the processing unit 310.

The visual processing unit 310 may comprise an external camera 320 that can receive photo and video information from outside of the band 150. Additionally, the visual processing unit 310 may comprise various image processing components, including but not limited to a graphics processing unit, support circuitry for the external camera 320, volatile and non-volatile memory, and other similar components. As depicted, unique from conventional smart watches, implementations of the present invention can comprise processing circuitry within the band 150. In contrast, conventional systems include the actual processing components behind the face of the watch. Though, some conventional systems may place hardware components such as cameras within a portion of a watch band, in contrast, to implementations of the present invention, actual processing components are not conventionally placed within the band. In particular, general processing components that are required for the fundamental operation of the smart watch are not placed within the band of conventional systems.

In at least one implementation, the processing unit 310 can also be located within the band 150 at a location that is not directly below the display 110. Additionally, in at least one implementation, the processing unit 310 can be located such that it is not immediately adjacent to the display 110, but is instead otherwise disposed within the band 150.

FIG. 3A also depicts the biometric unit 340 disposed at another location within the band 150. In particular, the biometric unit 340 is disposed between the display 110 and the hinge 130. The biometric unit 340 may comprise one or more of a variety of sensors. For example, sensors may be selected from among one or more accelerometers, one or more gyroscopes, one or more light sensors (e.g., for detecting ambient light), one or more biological sensors (e.g., for detecting heart rate, galvanic skin response, blood oxygen level, etc.), one or more microphones, one or more cameras, one or more thermometers (e.g., for detecting skin and/or air temperature), one or more barometers, one or more proximity sensors, one or more moisture sensors, one or more biometric sensors (e.g., fingerprint), etc. One will understand that one or more of these sensors may comprise additional components that rest on the outside of the band 150.

Additionally, the biometric unit 340 may also comprise user feedback components. For example, the biometric unit 340 may comprise a vibration unit 350. The processing unit 310 may activate the vibration unit 340 as a means to communicate to a user. For example, upon receiving an SMS text, an email, a phone call, or some other notification, the vibration unit 340 may activate to notify the user of a pending item.

In at least one implementation, the smart watch 100 can also comprise various antenna components 360(a-b) disposed within the smart watch 100. The antenna components 360(a-b) can comprise one or more short-range communications devices, such as BLUETOOTH, Wi-Fi, Near-Field Communications (NFC), ANT+, infrared transmitter/receivers, and other similar communication devices. As depicted in FIG. 3, the antenna component 360(a-b) may be disposed within the band 150 between the battery 300 and the hinge 130. In one or more alternate embodiments, the antenna component 360(a-b) can be disposed within the band 150 between the battery 300 and the latch 140. Further in at least one implementation, one or more antennas (e.g., WIFI, BLUETOOTH, 3G, etc.) can also be integrated into the same physical unit as the biometric unit 340 and the visual processing unit 330.

Additionally, in at least one implementation, the antennas can be positioned in a standalone unit 360b that is positioned between the display 110 and the hinge 130 or latch 140. As such, in at least one implementation, one or more of the antennas 360(a-b) may be positioned between the display 110 and the latch 140 and/or between the display 110 and the hinge 130. In particular, positioning the 3G antenna on an opposite side of the display 110 from the W-Fi antenna and BLUETOOTH antenna may provide better signal propagation for the 3G antenna. As such, in at least one implementation, the ability to place crucial components (e.g., antennas) within the watchband can provide significant benefits for overcoming interference between the various antennas. In particular, placing components in the watchband allows the components to be spaced much further apart than can be accomplished in conventional smart watches, where the majority of components are placed directly below the watch face.

Additionally or alternatively, the antenna components 360(a-b) can include one or more long-range communications devices, such as cellular, geographical positioning (e.g., GPS, Galileo, GLONASS, IRNSS, etc.), etc. As such, the smart watch 100 can be enabled to connect to cellular networks (e.g., GSM, CDMA, LTE, etc.) for data and/or voice communications. In addition, the smart watch 100 can be enabled to receive positional and/or time data from a geographical positioning system.

In various implementations of the present invention, the various internal components of the smart watch 100 can be located in places other than shown in FIG. 3. For example, in at least one implementation, the biometric unit 340 and the visual processing unit 330 can be locationally switched. Additionally, in at least one implementation, the various components can all be placed between the battery 300 and the hinge 130 or latch 140.

Accordingly, implementations of the present invention place a wide variety of components within the band 150 of the smart watch 100. In particular, in a bangle shaped band, as shown in FIGS. 1-3, implementations of the present invention can place the battery 300 and various components 310, 320, 330, 340, 350, 360(a-b) between the battery 300 and the hinge 130 or latch 140.

In at least one implementation, to allow communication between the battery and/or the various adjacent components 310, 320, 330, 340, 350, 360(a-b) at least one wire extends through the hinge 130. In at least one implementation, the hinge 130 comprises a continuous portion 132 that continuously connects the upper 102 and lower 104 portions of the smart watch 100 together, even when the latch 140 is open. In at least one implementation, at least one wire extends through the latch 140. In particular, the latch 140 may comprise an integrated electric connector, such that when the latch 140 is closed a circuit is completed between the battery and/or components 310, 320, 330, 340, 350, 360(a-b) and the upper portion 102 of the smart watch 100.

As discussed above, properly fitting the necessary components within a conventional smart watch in a visually attractive package is a shortcoming present within the conventional art. Conventional smart watches either forgo significant functionality to fit the necessary components within a small watch face or conventional smart watches attempt to fit nearly every component within the watch face, resulting in a bulky and unattractive arm piece. As disclosed above, implementations of the present invention overcome this problem with novel methods of placing batteries, accessories, and crucial components within the band 150. Additionally, implementations of the present invention provide novel features that allow communication between components in the lower portion 104 of the smart watch 100 with components in the upper portion 102 of the smart watch.

In addition to the various components, configurations, and form factors disclosed above, in at least one implementation of the present invention, the smart watch 100 also comprises a novel user interface. One will understand that implementing intuitive and effective user interfaces within conventional smart watches has resulted in several shortcomings. In particular, many conventional smart watches run operating systems that were originally designed for smart phones.

Most of these operating systems rely upon a home screen model. This model comprises one or more screens where applications are arranged in a grid-like pattern. These home screens are somewhat analogous to computer desktops. Within smart phones, home screens provide several benefits. For example, home screens provide a user with a starting place, where important applications and functionalities can be arranged and readily accessible. For instance, a user may place a phone application and internet application in a readily available spot on the home screen. Additionally, home screens can provide a default location for a user to resort to when attempting to move from a first application to a second application.

When dealing with the extremely limited screen real estate on a conventional smart watch, however, displaying a large number of applications on a single home screen has several obvious problems. Accordingly, various conventional smart watches have experimented with and implemented a wide variety of different user interface schemes. These conventional user interfaces suffer from several shortcomings. For example, conventional user interfaces on smart watches move too far from a useful home screen. For example, some conventional smart watch user interfaces allow a user to sort through a potentially large number of applications one at a time. In particular, a user may push a button or perform a touch gesture on the conventional smart watch to cycle through the applications. Some of these conventional smart watches may provide a pseudo home screen, which often comprises a digital representation of a watch face, but which provides little interactive functionality.

This scheme has several shortcomings. For example, the pseudo home screen (i.e., the digital watch face), while potentially providing useful information about time and date, fails to provide a user with quick access to crucial applications/functionalities within a single screen. Additionally, returning the user to the digital watch face also may return the user to the very beginning of an application list. For example, if a user has ten applications on a conventional smart watch and is currently executing the ninth application, but desires to switch to the tenth application. Returning to the home screen (e.g., the digital watch face) may require the user to cycle through all ten applications before being able to access the tenth application. Accordingly, there is a need for a smart watch user interface that provides a user with some of the functionality of a home screen, while at the same time not suffering from the obvious shortcomings of placing a full smart phone based home screen onto the limited screen real estate of a smart watch.

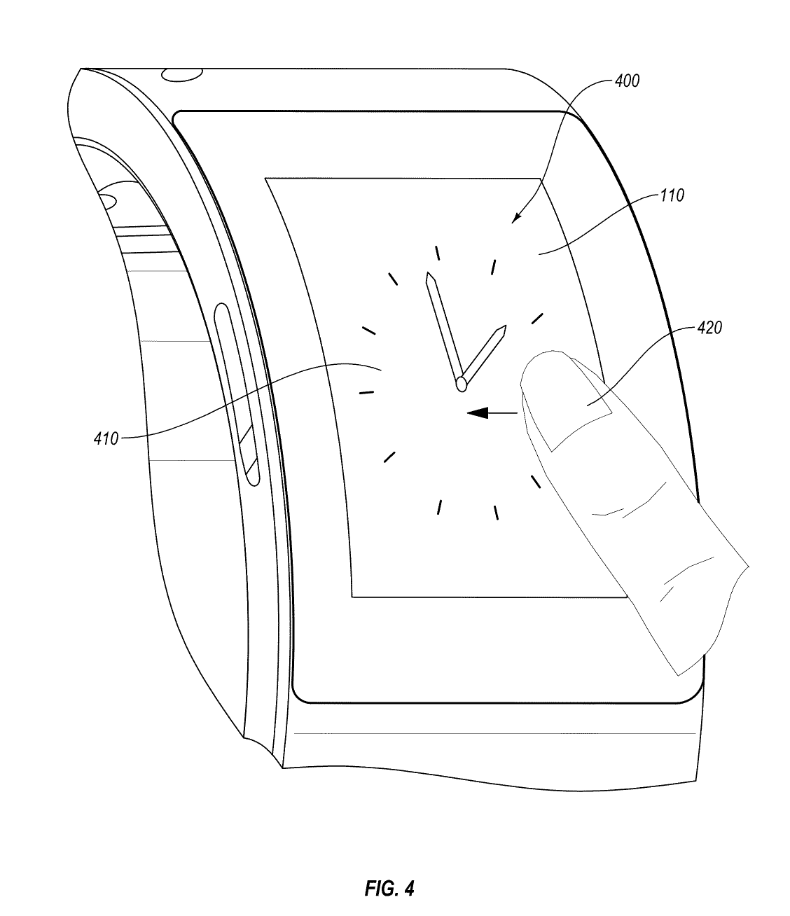

FIG. 4 depicts an implementation of a smart watch interface 400. In particular, the depicted smart watch interface 400 comprises a digital watch face 410. In at least one implementation, a wide variety of different types and styles of digital watch faces 410 are available for a user to choose between. Additionally, one will understand that the digital watch face 410 is merely exemplary.

In at least one implementation, when the smart watch is initially activated, the smart watch interface 400 is displayed. As such, the first view that is provided to a user may comprise a virtual depiction of a traditional watch face. In at least one implementation, the smart watch is activated automatically when the user lifts the smart watch. For example, the accelerometers within the smart watch may detect a movement that indicates a user is viewing the face of the watch, and based upon this movement, the smart watch can automatically activate.

In addition, in at least one implementation, performing a specific interaction with the smart watch can activate the smart watch. For example, double tapping the body of the smart watch can cause the smart watch to activate. In particular, double tapping the watchband of the smart watch can cause the smart watch to activate. Alternatively, pressing a hardware button on the smart watch can also cause the watch to activate.

Additionally, FIG. 4 depicts a detected contact 420 on the display 110. The detected contact 420 can comprise a detected finger contact with the display 110, a detected stylus contact with the display 110, or some other detection of user interaction with the display 110. In FIG. 4, the detected contact 420 is detected on the right side of the display 110 and is moving (as indicated by the arrow) towards the left side of the display. In alternate implementations, the detected contact 420 can both originate and be directed towards areas other than those shown. For example, the detected contact 420 may originate at the top of the display 110 and be directed towards the bottom of the display 110. In contrast, in at least one implementation, the detected contact 420 can be detected in the approximate middle of the display 110 and be directed towards a particular side of the display 110. Additionally, in at least one implementation the detected contact 420 may be required to cross the entire display (i.e., from side to side) before a particular action results.

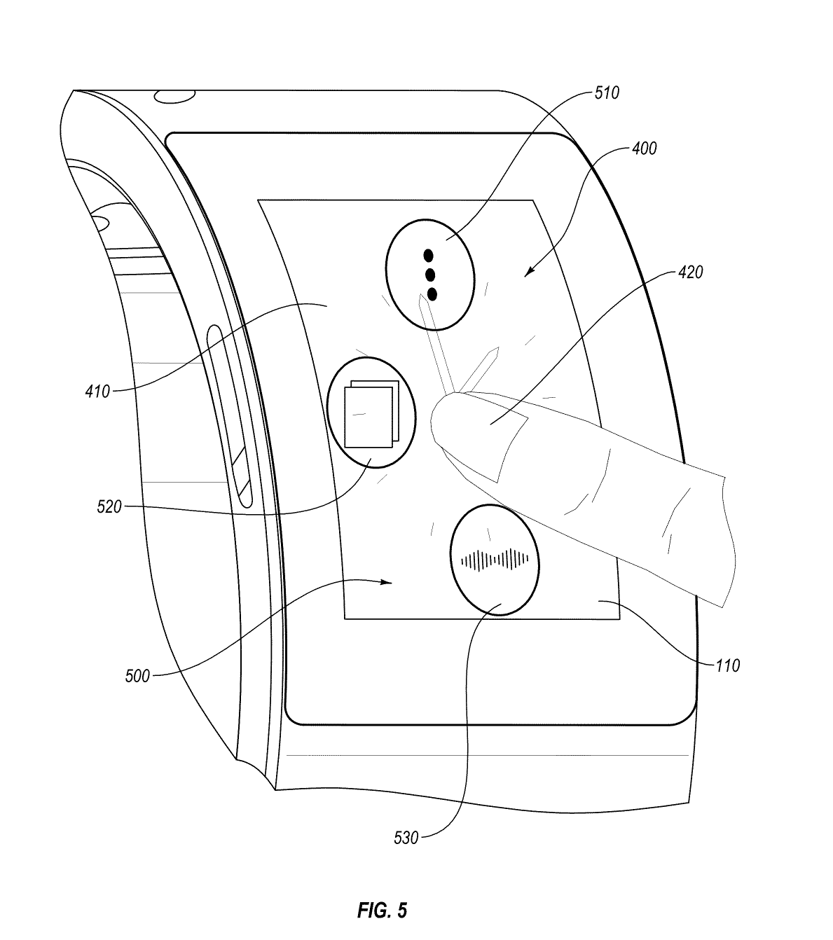

FIG. 5 depicts the smart watch user interface 400 of FIG. 4 after the detected contact 420 has moved to approximately the middle of the display 110. In at least one implementation, after detecting a contact 420 in a pre-defined location (e.g., the right side of the display 110) followed by a pre-defined movement of the contact (e.g., towards the center of the display 110), the smart watch user interface 400 displays select function indicators 500. In accordance with the above disclosure, however, one will understand that in alternate implementations other pre-defined locations and pre-defined movements may be tied to launching the select function indicators 500. Additionally, in at least one implementation, a pre-defined gesture (e.g., two finger tap, one finger touch for an extended time, etc.) can also launch the select function indicators 500.

In the implementation depicted in FIG. 5, the select function indicators 500 comprise a carousel application browser icon 510, a user information icon 520, and a voice features icon 530. In at least one implementation, the carousel application browser icon 510, a user information icon 520, and a voice features icon 530 can quickly and easily provide a user access to the key functions of the smart watch 100. In alternate implementations, however, additional or different icons and functions may be included within the select function indicators 500. Further, in at least one implementation, the select function indicators 500 may be user adjustable, such that a user can determine one or more of the icons that should be included within the select function indicators 500.

As depicted, in at least one implementation, the select function indicators 500 are overlaid on the smart watch user interface 400 that was previously present. Additionally, in at least one implementation, the underlying smart watch user interface 400 can continue to update itself. For example, the clock can continue to keep and display accurate time even though the select function indicators 500 are overlaid on the display 110. Additionally, in at least one implementation, the select function indicators 500 can be displayed over any smart watch interface 400. For example, the select function indicators 500 could be accessed within a smart watch interface 400 that comprises an internet portal, an SMS text interface, a camera interface, some other application, or any other interface on the smart watch 100. In contrast, in at least one implementation, launching the select function indicators 500 causes the underlying user interface to disappear.

The select function indicators 500 can also be removed from the screen. In at least one implementation, performing the opposite action required to activate the select function indicators 500 will cause the select function indicators 500 to be removed from the screen. For example, when a contact is detected in approximately the middle of the display 110 and the contact moves towards the right side (i.e., the opposite contact and movement of FIGS. 4 and 5) the select function indicators 500 can be removed from the screen, and the user can continue on the smart watch user interface 400 that was overlaid by the select function indicators 500. Additionally, in at least one implementation, once a user breaks continuous contact with the display the select function indicators automatically remove themselves.

Accordingly, implementations of the present invention comprise select function indicators 500 that overcome several of the problems within conventional smart watches. For example, implementations of the select function indicators 500 can be accessible from any screen within the smart watch 100. Additionally, in at least one implementation, the select function indicators 500 overlay the previously accessed smart phone user interface 400 and allow a user to return to the previously accessed smart phone user interface 400 directly from the select function indicators 500.

Using the select function indicators 500, a user is provided with quick access, from anywhere within the smart watch user interface 400, to several key functions of the smart watch 100. Additionally, the select function indicators 500 are laid out in a way that a user can easily select one of the provided options without accidently selecting the wrong icon. While the depicted number of icons within the select function indicators 500 is three, in alternate implementations fewer than three or more than three icons can be depicted. For example, an implementation of select function indicators 500 can comprise four, five, six, or more icons.

Once the select function indicators 500 are displayed a user can select one of the icons 510, 520, 530 to execute an application. In at least one implementation, selecting an icon comprises the user breaking contact with the screen, once the select function indicators 500 are displayed, and then again making contact with the screen on a particular icon 510, 520, 530. In an alternate implementation, selecting an icon comprises the user maintain the initial contact 420 (from FIG. 4) and sliding the contact to a particular icon 510, 520, 530. In other words, the movement of displaying the select function indicators 500 and selecting a particular icon 510, 520, 530 comprises a continuous movement where contact with the display 110 is maintained. In at least one implementation, once a user stops contact 420 with the display, the select function indicators 500 automatically are removed from the screen.

In at least one implementation, the select function indicators 500 provide a user with a quick method to access a desired application within the smart watch. For example, the select function indicators 500 can provide a user with quick access to a voice features 530 application. Using the voice features 530 application, a user can vocally request a particular smart watch application and/or vocally request that the smart watch perform a particular function.

Additionally, the select function indicators 500 can provide the user with quick access to the carousel application browser icon 510. In at least one implementation, the carousel application browser icon 510 provides a user with access to the applications currently stored on the smart watch. Accordingly, the selecting function indicators 500 can provide a means for a user to quickly and easily access functions of the smart watch, while overcoming the shortfalls of conventional smart watch interfaces.

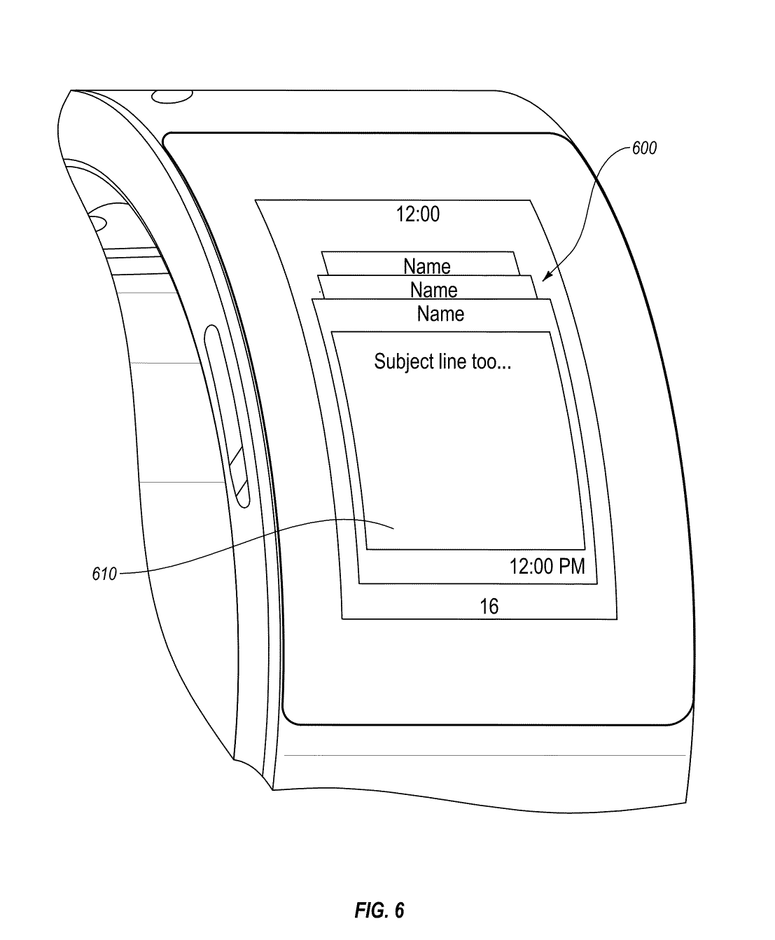

FIG. 6 depicts an implementation of the user information application 600 that is associated with the user information icon 520. As depicted, in at least one implementation, the user information application 600 displays various notifications and user information items in a stacked card format. In particular, one or more cards 610 are displayed on the screen. Each card comprises information relating to a particular item. For example, the cards can comprise weather notifications, internet RSS feed notifications, SMS texts, emails, missed call notifications, voice mail notifications, and other similar information. In at least one implementation, information from a particular application can appear spread across multiple cards 610.

The user information application 600 can comprise notifications provided from other applications on the smart watch 100. Selecting a particular card 610 may execute an application that is associated with the information within the card or it may allow a user to create information within the user information application 600. For example, a particular card 610 may comprise an SMS text. In at least one implementation, selecting the card 610 may execute a dedicated SMS text application or it may allow a user to create a response SMS text within the user information application 600.

Additionally, in at least one implementation, navigating between the cards 610 can be achieved in my swiping the cards downward and/or upwards. In at least one implementation a swipe must originate from an edge of the display 110. In contrast, in at least one implementation, a swipe must originate from the middle of the display (or some other location other than a side) and be directed in a particular direction.

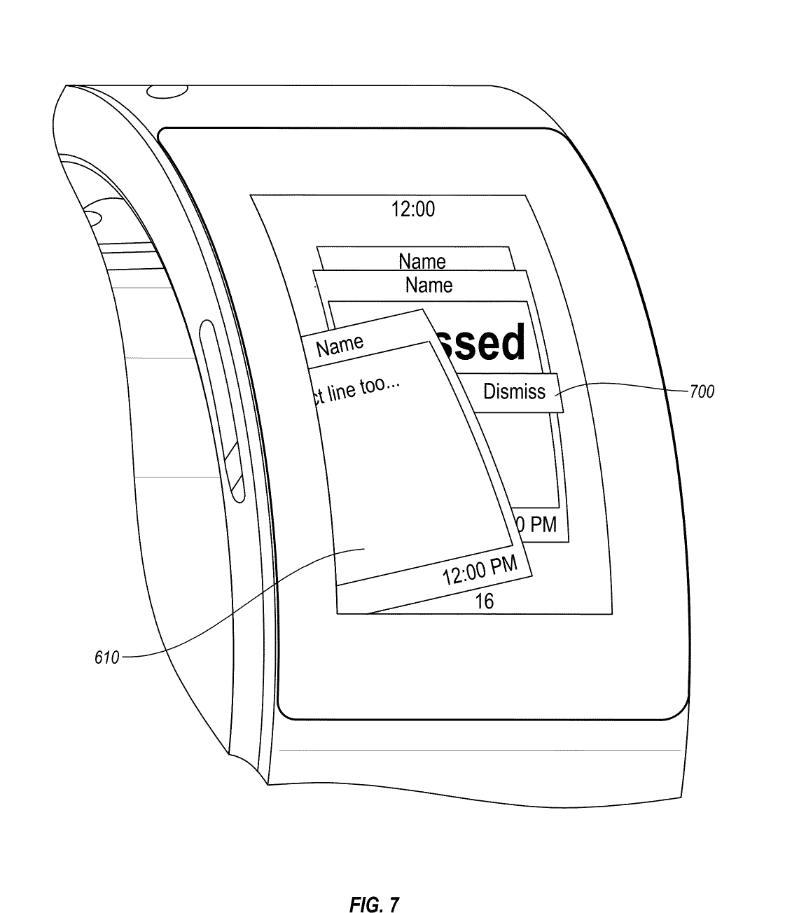

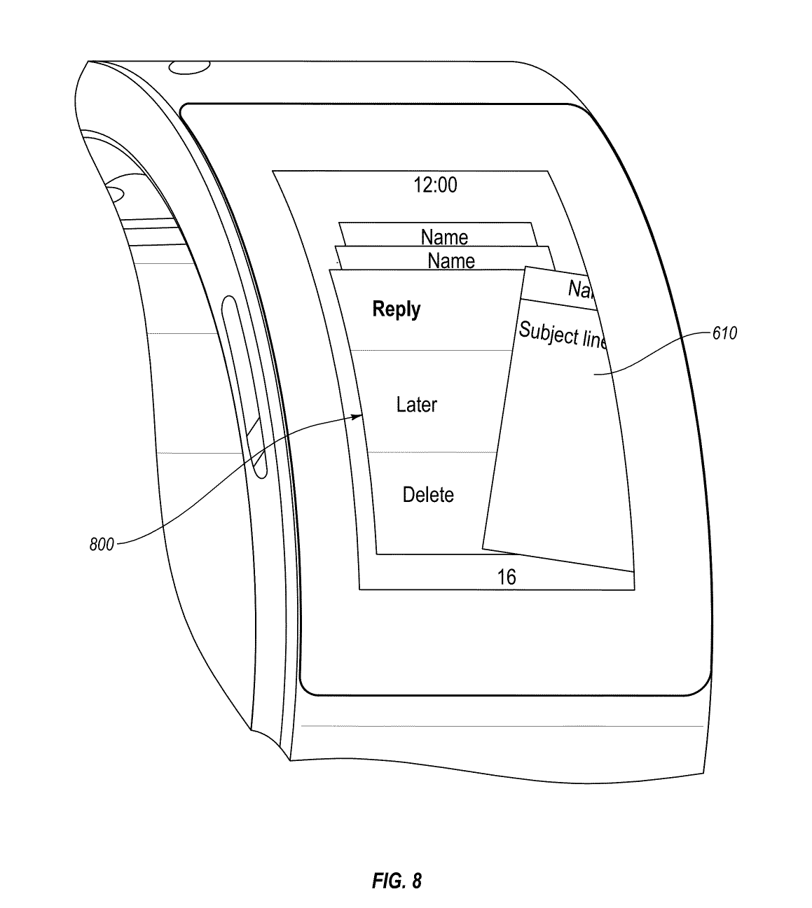

In at least one implementation, additional movements can reveal various operations within the user information application 600. For example, FIG. 7 depicts a “dismiss” operation 700. In at least one implementation, this operation 700 can be revealed by swiping the active card 610 to the left. Similarly, FIG. 8 depicts similar operations 800 that can be revealed by a swipe to the right. In at least one implementation, the operations 700, 800 are standardized within the user information application 600. For example, in at least one implementation a left swipe may reveal a dismiss operation 700 while a right swipe may reveal operations 800 that are specific to the information on the card 610.

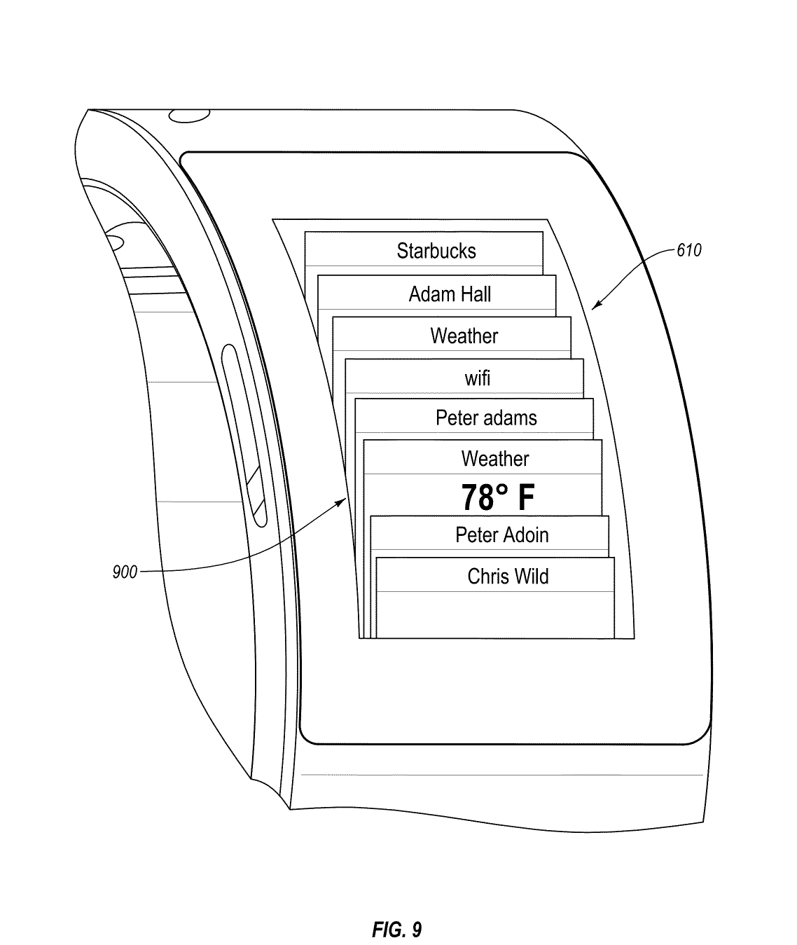

FIG. 9 depicts an implementation where the various cards 610 are displayed in a three-dimensional stacked view 900. In at least one implementation, a user can easily scroll through the various cards and pick a particular card 610 of interest. One will appreciate that this view may be particularly useful when a user is seeking out a particular card 610 among a large number of cards 610. In at least one implementation, the three-dimensional stacked view 900 is viewable in response to a particular detected contact and movement. For example, a double tap, a two-finger tap, a pinch, or some other contact and/or motion may activate the three-dimensional stacked view 900.

Additionally, in at least one implementation, the various cards 610 can be displayed end to end such that a cards entire contents are viewable within display 110. A user may then be able to scroll through the cards using a swiping motion.

FIG. 10 depicts an implementation of a carousel application browser 1000. The carousel application browser 1000 may be accessible from the select function indicators 500, from an independently executable application, by pushing a physical button on the smart watch 100, by performing a particular gesture on the watch, or through any other access means. In at least one implementation, the carousel application browser 1000 provides a scrollable depiction of icons associated with various applications installed on the smart watch 100. For example, FIG. 10 depicts icons associated with FACEBOOK and TWITTER.

In at least one implementation, upon entering the carousel application browser 1000, a user is able to scroll from top to bottom through one or more applications that are available on the smart watch 100. As a user scrolls colors in the background of each respective application icon can seamlessly transition between each other. For example, a FACEBOOK application may comprise a dark blue background while a messaging application may comprise a green background. In at least one implementation, when scrolling from the FACEBOOK application to the messaging application, the background displayed on the screen seamlessly transitions from dark blue to green. In other words, the color in the background transitions from the dark blue to the green using a continuous gradient as the user scrolls from the FACEBOOK application to the messaging application. As such, a user is provided with an attractive and intuitive visual indication of different application icons scrolling.

Additionally, in at least one implementation, a user may be able to access various options within the carousel application browser 1000. For example, similar to the interface shown in FIGS. 7 and 8, a user may be able to swipe left or right, or perform some other predetermined contact and movement, to access options relating to the individual applications that are represented within the carousel application browser 1000. In at least one implementation, swiping a first direction, possibly left or right, will allow the user to access global options that apply to all applications (e.g., delete). In contrast, in at least one implementation, swiping a second direction, possibly left or right, will allow the user to access application specific options that apply to the application currently displayed and/or acted upon (e.g., change login, create message, etc.).

In at least one implementation, the order of applications within the carousel application browser 1000 is determinable by a user. For example, a user may desire to place applications that are most commonly accessed so that they appear first within the carousel application browser 1000. In contrast, in at least one implementation, the applications are automatically ordered by the carousel application browser 1000. The carousel application browser 1000 may order the applications in the order in which they were most recently accessed, in the order of most commonly accessed, or through some other intelligent ordering method. For example, in at least one implementation the carousel application browser 1000 can intelligently order the applications based upon the user's location, the time of day, events scheduled in the user's calendar, or biometric information from the user. For instance, the carousel application browser 1000 may order a train payment application first when it detects that the user is walking into a train station. Similarly, the carousel application browser 1000 may order a fitness application first based upon a scheduled exercise time.

The carousel application browser 1000 depicted in FIG. 10 shows two application icons 1010 within the same screen. In at least one implementation, however, only a single entire application icon 1010 is displayed at a time. Nevertheless, portions of multiple icon application icons 1010 may be displayed as a user scrolls from a first application icon to a second application icon. In particular, an animation may depict a first icon leaving the screen as a second icon enters the screen. One will understand that a similar interface and animation may be used for more than a single application icon 1010 at a time.

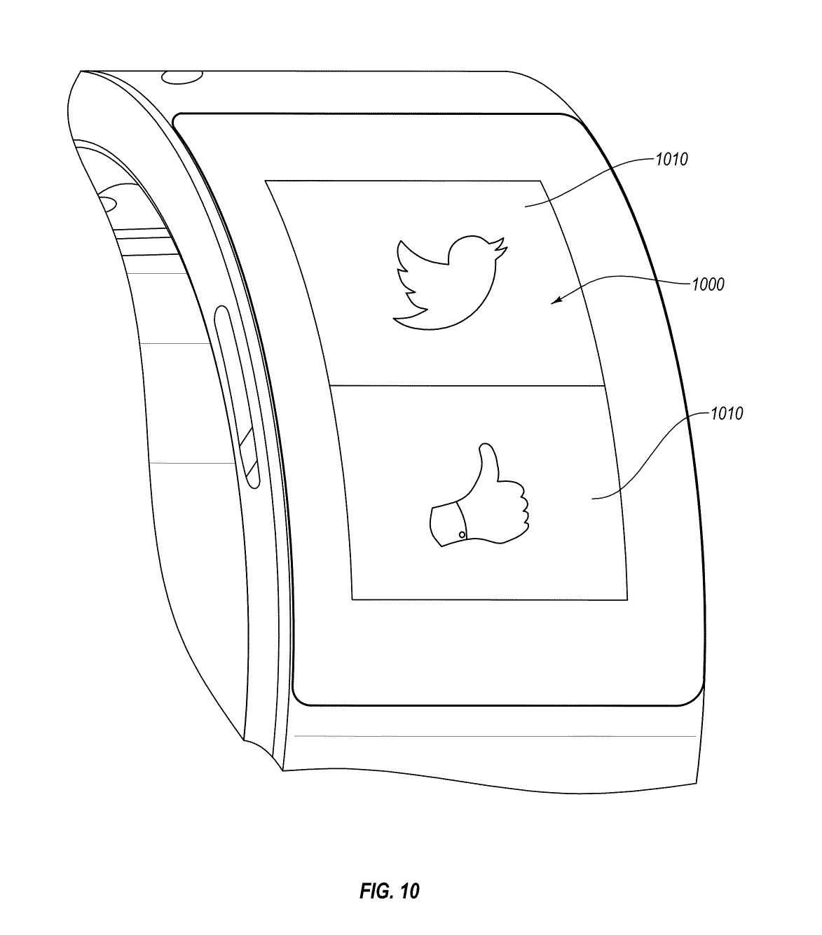

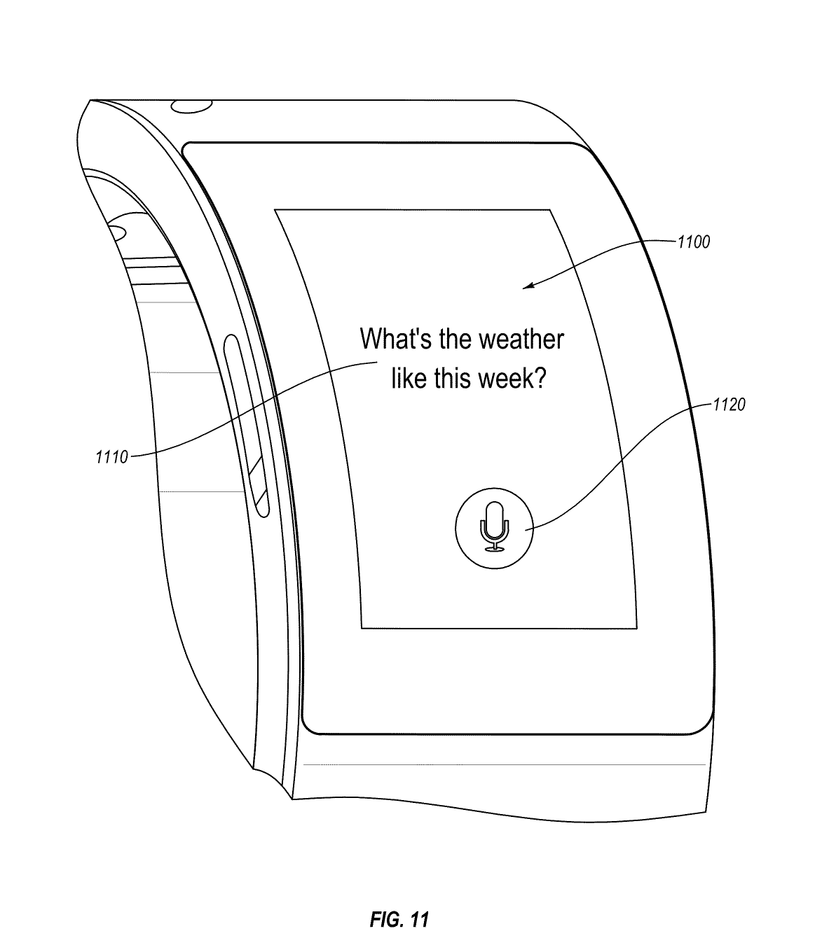

FIG. 11 depicts a voice features application 1100 that can be displayed responsive to a user selecting the icon for voice features 530 from the select function indicators 500. In at least one implementation, the voice features application 1100 may also be accessible by pushing a button 200, performing a particular contact and movement on the display 110, or by issuing a particular voice command.

The voice features application 1100 may have access to one or more other standalone applications within the smart watch 100. For example, in at least one implementation, using the voice features application 1100 a user can send an SMS text, initiate a phone call, request a weather update, request directions, access a fitness application, or perform a variety of other functions that are available within the smart watch 100 system.

As depicted in FIG. 11, in at least one implementation, the voice features application 1100 transcribes the user's vocal words 1110. When transcribing a user's vocal words 1110 the voice features application 1100 can perform various filtering and smart interpretation to determine the user's commands. For example, the voice features application 1100 can use a dictionary to match interpreted vocal commands to the closest word in the dictionary. In at least one implementation, the interpretation of the user's vocal words 1110 is performed at a server to which the smart watch 100 communicates.

FIG. 11 also depicts an active icon 1120 within the voice features application 1100. The active icon 1120 may flash or perform some other animation to indicate that the voice features application 1100 is in a listening mode. In contrast to being in a listening mode, in at least one implementation that active icon 1120 may comprise an animation that indicates the voice features application 1100 is in a processing mode. During processing mode the voice features application 1100 may be communicating to server and may be unable to receive immediate voice commands.

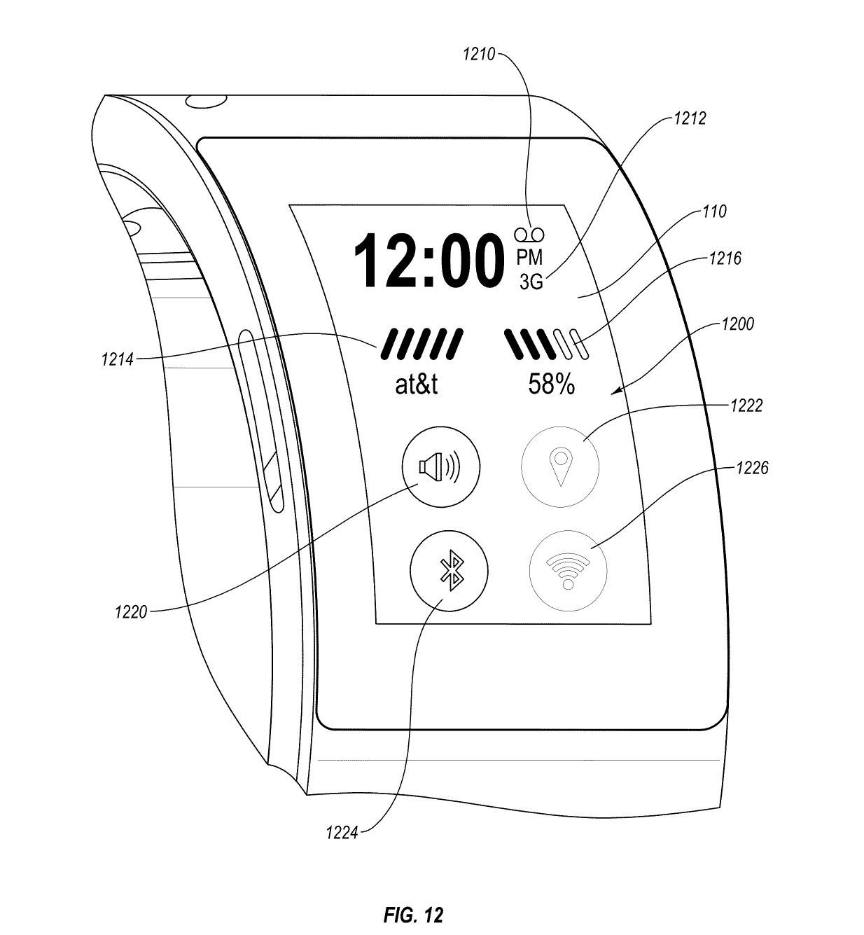

FIG. 12 depicts a status information screen 1200. The status information screen 1200 can be accessible from any other interface within the smart watch 100. In at least one implementation, the status information screen 1200 is accessible by contacting an edge of the screen 110 and moving the finger, in continuous contact, towards an opposite edge of the screen 110.

Additionally, in at least one implementation, the status screen is accessible by contacting the top of the screen 110 for an extended period of time, and then dragging a finger downward after status screen becomes available. For example, the status information screen 1200 may be accessible by contacting the top of the screen 110 for a period of time of one second and then dragging a finger towards the bottom of the screen 110. In at least one implementation, after a user contacts the top of the screen for a sufficient amount of time, and before the user drags a finger downward, a visual indication appears on the screen to indicate that the status information screen 1200 is now accessible by dragging a finger downward.

In at least one implementation, hiding the status information screen 1200, except when explicitly accessed, provides several benefits. For example, due to their form, smart watches 100 must always balance screen real estate with ease of accessing and interacting with information. This is particularly true when, like in the present case, the smart watch 100 comprises novel cellular communication features and other such advanced features. On one hand, like most cellular telephones, certain status information, such as single strength, signal type, battery strength, etc., are useful indicators. On the other hand, watch sized devices are not well suited for information dense screens.

Accordingly, significant advantages can be gained by providing a status information screen 1200 that is accessible from anywhere in the mobile watch user interface, but is otherwise hidden from view. For example, the status information screen 1200 of FIG. 12 provides information relating to the presence of voicemail 1210, the current network type 1212, the network signal strength 1214, and the battery strength 1216. One will understand that this information may be difficult to fit within the standard smart watch user interface. In particular, this information may be difficult to position in a readily viewable way when the smart watch is executing an application. Accordingly, providing a simple contact and movement (e.g., a downward swipe) that can access the status information can provide significant advantages over the prior art.

In addition to status information, the status information screen 1200 of FIG. 12 also comprises specific settings. In particular, the status information screen 1200 displays a sound setting 1220, a location service setting 1222, a BLUETOOTH setting 1224, and a Wi-Fi setting 1220. In at least one implementation, these settings function as toggle switches to activate or deactivate particular features. For example, selecting the location services setting 122 may activate or deactivate a GPS module within the smart watch 100. Accordingly, a simple interface is provides through which a user can quickly access particular settings from any interface within the smart watch 100.

Additionally, in at least one implementation, a prolonged contact with a specific settings icon can cause an associated application to launch. For example, a prolonged contact with the Wi-Fi settings 1220 icon can cause a Wi-Fi menu to launch. This menu may provide a user with the ability to select a particular Wi-Fi network, enter a passcode, forget a particular Wi-Fi network, or perform some other function. Accordingly, implementations of the present invention provide significant and novel user interface interactions. In particular, a status information screen 1200 is accessible universally through the smart watch and provides user with an intuitive way to activate various services and/or accessing settings and applications associated with the services.

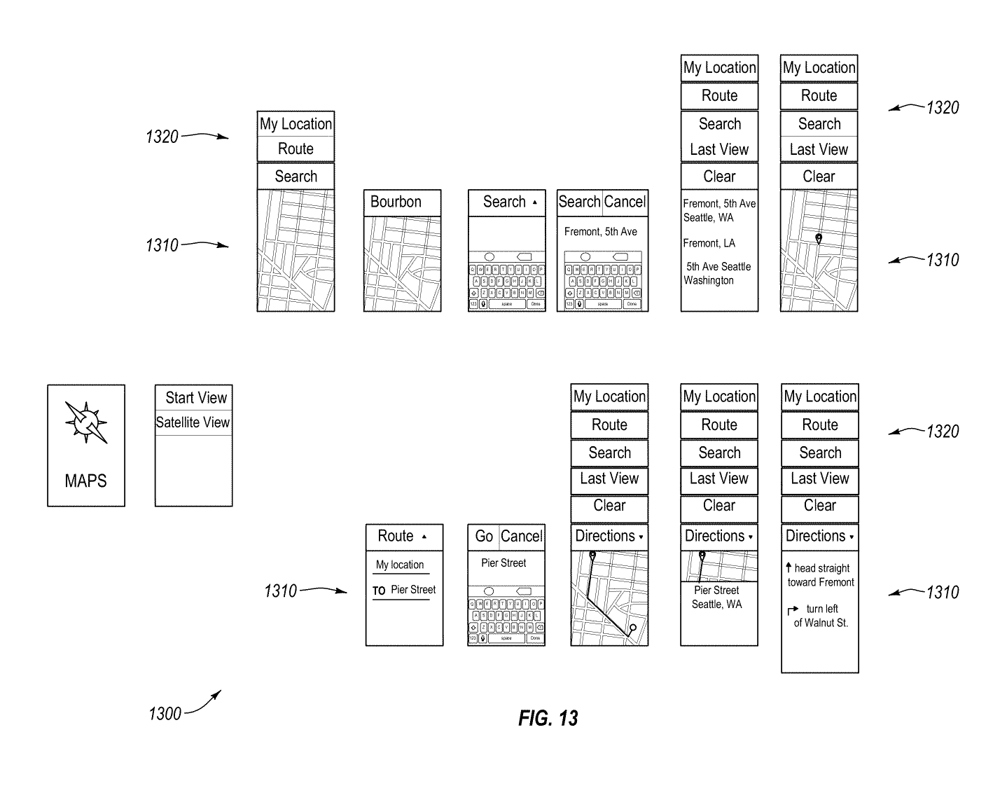

FIG. 13 depicts an implementation of an interface for a map application 1300. The interface is provided for exemplary purposes, and one will understand that a similar interface can be applied to a variety of different applications. In particular, FIG. 13 depicts various possible screens and menu items that may be presented to a user when seeking directions.

The depicted interfaces comprise information screens 1310 and menu items 1320. The menu items 1320 are positioned within the figure to indicate that they are scrollable within the smart watch interface. In particular, the menu items 1320 may be accessible by scrolling from the top of the screen. In at least one implementation, contacting the screen at the very top and scrolling down will reveal the status information screen 1200. In contrast, contacting the screen near the top, but not at the top, and scrolling downward will reveal the menu items 1320. “Near the top” may comprise any contact that does not overlap with the edge of the display 110, any contact that is substantially lower than the top 10% of the display 110, or some other contact that is not immediately at the edge of the display 110. Additionally, in at least one implementation, contacting the display 110 at the top for a brief period of time, in contrast to a prolonged period of time, and then scrolling downward will reveal the menu items 1320.

Accordingly, FIG. 13 depicts a novel method of providing a user with information screens 1310 and menu items 1320 within a smart watch 100. In particular, the depicted novel interface allows a user to have a large portion of the limited smart watch screen dominated by information of interest. At the same time, the disclosed interface can provide a user with a wide variety of menu items 1320 that are large enough to be easily selected with an touch input device (e.g., a finger).

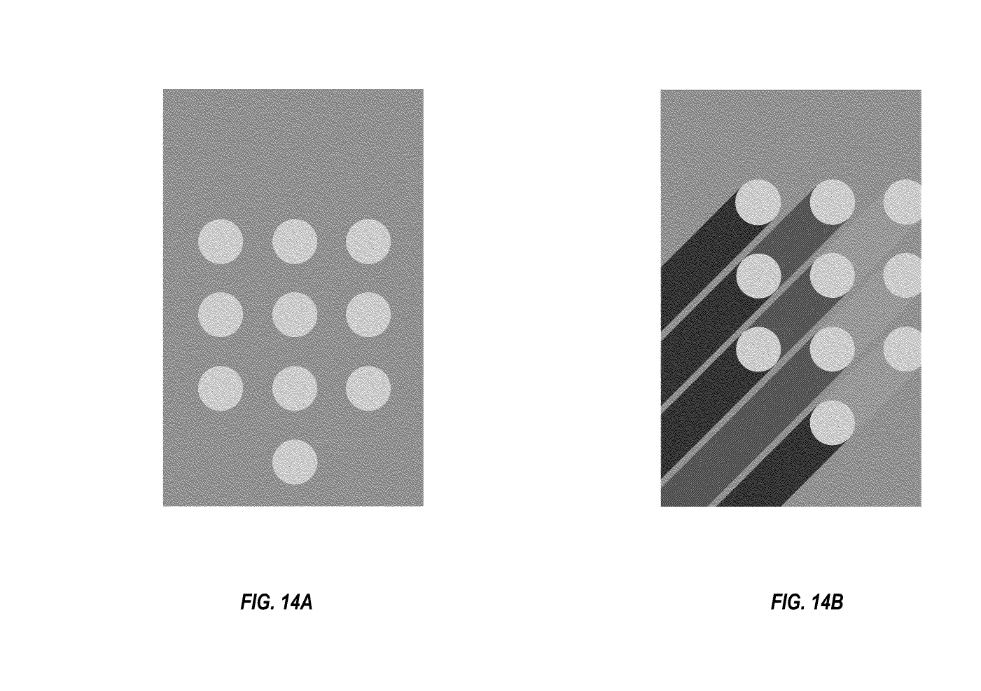

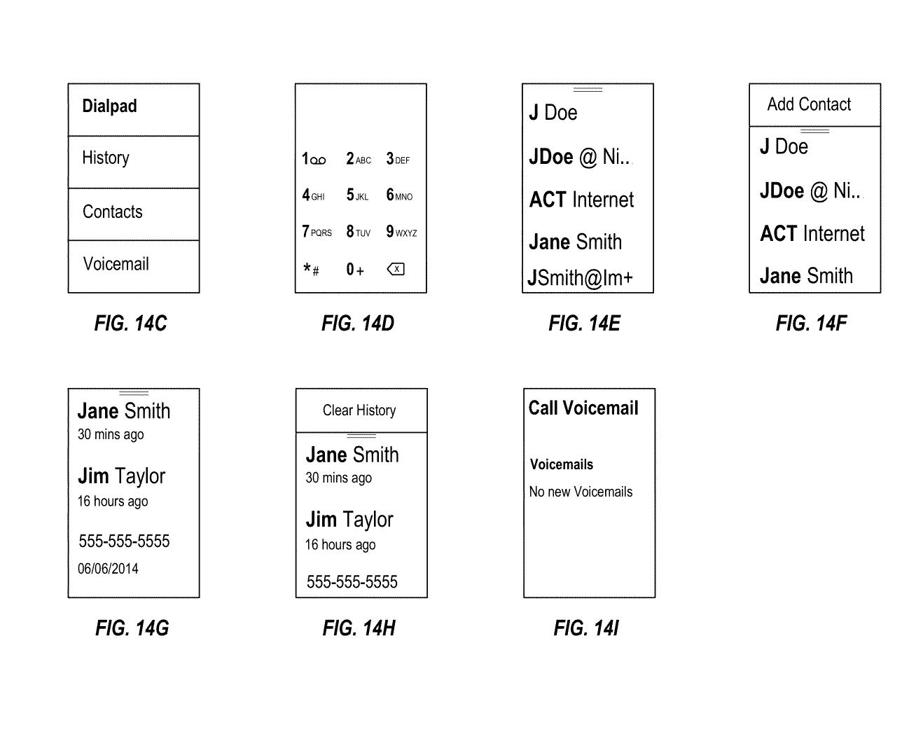

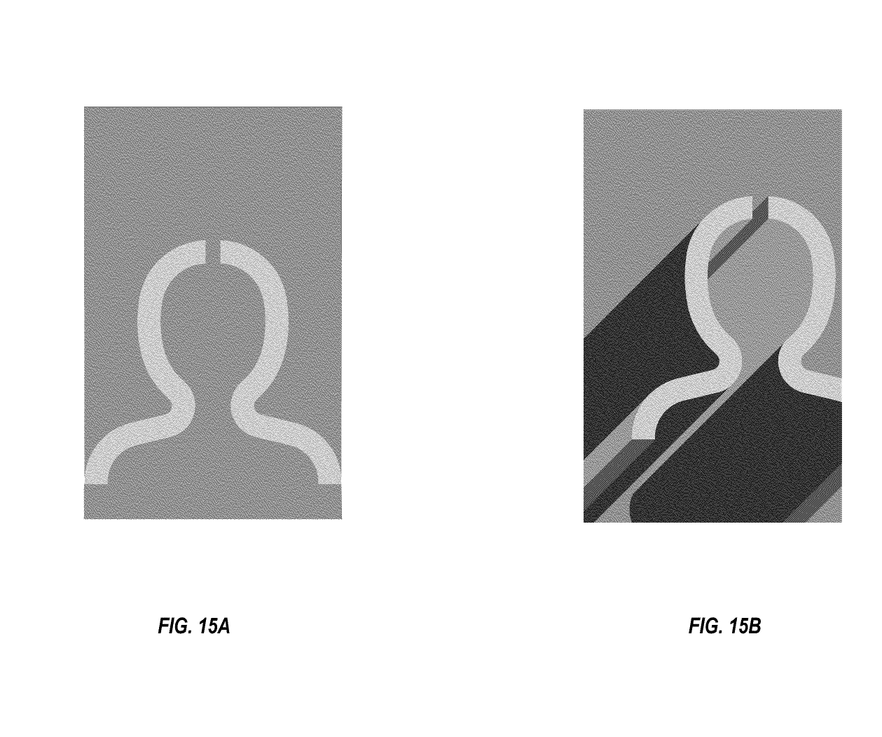

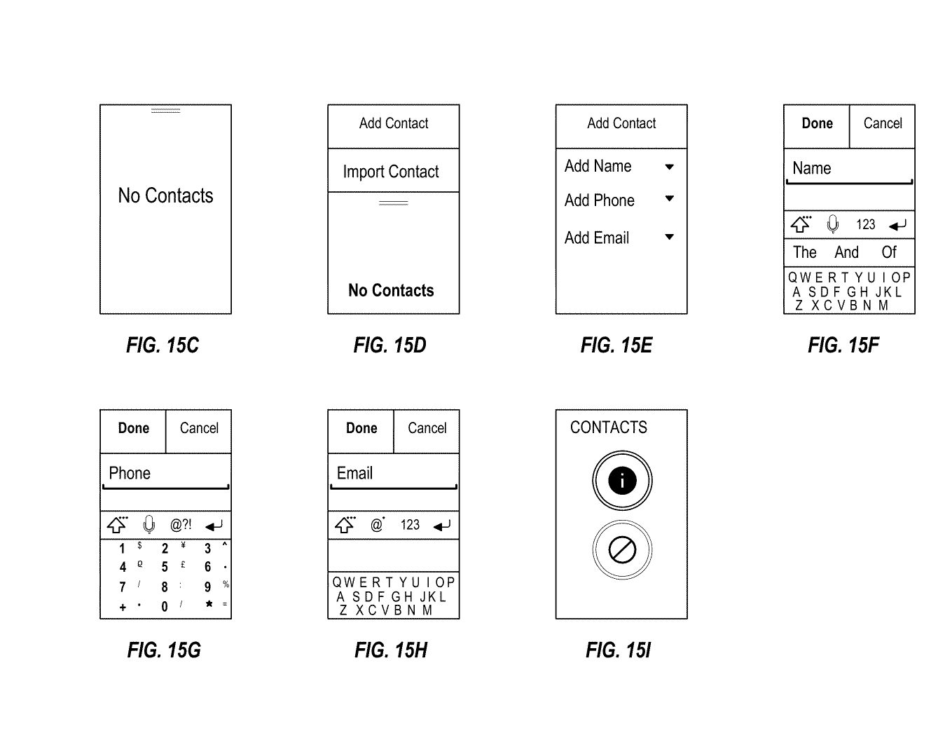

FIGS. 14A-14I depict various implementations of an interface for a phone application. In particular, FIGS. 14A and 14B depict an icon for a phone application. In at least one implementation, as a user scrolls through a list of applications the icon of FIG. 14A is initially displayed. Once a user remains on a particular icon for a prolonged period of time (e.g., one second), the icon of FIG. 14A transforms into the icon of FIG. 14B and generates a three-dimensional image of the icon as further demonstrated in figures A and B of FIGS. 15-22. In at least one implementation, a user can activate the application by selecting the icon within the smartphone display 110. Upon selecting the icon, a user is presented with the phone application main menu as depicted in FIG. 14C.

FIG. 14C displays various features and interfaces that are available within the phone application. For instance, FIG. 14C depicts options for a dial pad interface, history interface, contacts interface, and voicemail interface. One will understand, however, that various additional or different interface may be available in alternative implementations. In at least one implementation, the interfaces depicted in FIG. 14C represent various feature interfaces that are available within the phone application. Specifically, each of the interfaces displayed within FIG. 14C may comprise a unique interface within the phone application.

Additionally, in at least one implementation, the interface of FIG. 14C is displayed in response to left-to-right swipe across the face of the smart watch. In contrast, in at least one implementation, a top-to-bottom swipe across the face of the smart watch causes application specific options to be displayed. For example, application specific option may include group call options, delete voice mail options, redial options, and other similar options that are not necessarily associated with an entirely new screen within the phone application. One will understand, however, that the gestures described above as required to display the feature interface of FIG. 14C versus the application specific options are merely exemplary. In alternate implementations, different gestures may be used. For example, a right-to-left swipe may reveal the feature interfaces depicted by FIG. 14C, while a bottom-to-top swipe may reveal the application specific options.

FIG. 14D depicts an interface that may be displayed to a user after the user selects the dial pad option of FIG. 14C. The dial pad feature depicted in FIG. 14D comprises an alphanumeric keyboard and a display portion to display a currently dialed phone number. Using the dial pad feature, a user can initiate a cellular phone call using conventional means.

FIG. 14E depicts an interface that may be displayed in response to user selecting the contacts option of FIG. 14C. The contacts interface of FIG. 14E can comprise an alphabetical listing of contacts that are stored within the smart watch. In at least one implementation, a user can access a keyboard to perform a quick search of the contacts within the contact application. Additionally, in at least one implementation, a user can search through the contacts using a vocal command.

Similar to conventional systems, a user can select a contact from within the contact interface of FIG. 14E and automatically initiate communication with that contact. Additionally, a user can select a default communication type for each contact. For example, a user may associate a first contact's phone number with voice phone calls, while associating a second contact's phone number with SMS texting. As such, when the user selects the second contact, a text message application may be automatically executed.

FIG. 14F depicts an interface for adding a contact to the phone application. In at least one implementation, adding a contact can be accomplished through manual entry of contact information through an on-screen keyboard, through vocal commands, or by importing the contact from an external source. Additionally, in at least one implementation, the adding a contact through the phone application, also adds a contact to a dedicated contact application.

FIG. 14G depicts an implementation of a history feature. This history feature of FIG. 14G may be displayed upon a user selecting the history feature depicted in FIG. 14C. The history interface depicts various recent phone calls and communications that have been received through the phone application. Additionally, the history interface can display information regarding each communication. For instance, the history interface may depict a caller ID field, indicating who made the communication, and a time field, indicating when the communication was received. Additionally, FIG. 14H depicts an option to clear the history. In at least one implementation, in addition to displaying a communication history, the history interface may also allow a user to initiate a return communication by selecting a name within the history.

FIG. 14I depicts a voicemail interface. The voicemail interface of FIG. 14I may be displayed upon a user selecting the voicemail interface within FIG. 14C. In at least one implementation, the voicemail interface of FIG. 14I allows for non-sequential access to voicemails. For example, the voicemail interface may display a plurality of different voicemails from individual callers. A user can then select any individual voicemail and immediately access that voicemail.

FIGS. 14A-14I depict various implementations and features within a phone application for a smart watch. As depicted and described, a user is provided with tremendous functionality and ease-of-use. In particular, the depicted user interfaces provide highly efficient use of limited smart watch display area.

FIGS. 15A-15I depict various user interfaces within an implementation of a contacts application. In particular, FIGS. 15A and 15B depict an icon for a contacts application. In at least one implementation, as a user scrolls through a list of applications the icon of FIG. 15A is initially displayed. Once a user remains on a particular icon for a prolonged period of time (e.g., one second), the icon of FIG. 15A transforms into the icon of FIG. 15B. In at least one implementation, a user can select the contacts icon of FIG. 15B to launch the contacts application within a smart watch.

In at least one implementation, the contacts application of FIGS. 15A-15I is the same as the contacts feature that is accessible from the phone application main menu of FIG. 14C. Accordingly, the figures and descriptions relating to FIGS. 14E and 14 F may also apply to the implementations discussed regarding FIGS. 15A-15I. For example, while FIG. 15C depicts a contact application without any stored contacts, and FIG. 14E depicts a contacts application with multiple stored contacts, in at least one implementation that function of the two interfaces is the same.

FIG. 15D depicts an implementation of the contacts application including an “add contact” option and an “import contact” option. FIG. 15E depicts a user interface that is displayed in response to user selecting the “add contact” option of FIG. 15D. In particular, FIG. 15E depicts options to add a name, add a phone number, or add an email to the contacts application. Upon selecting any of the options of FIG. 15E, the smart watch can display the appropriate user interface from any of FIG. 15F, FIG. 15G, or FIG. 15H.

FIG. 15I depicts a user interface for deleting a contact or accessing additional information regarding the contact. In particular, if the user selects the information icon the smart watch can display a contact name, phone number, email address, and other similar information. In contrast, if the user selects the delete option, the entire contact is removed from the smart watch. In at least one implementation, the interface of FIG. 15I is depicted after prolonged touch on a particular contact.

Returning to FIG. 15 D, a user may also select an import contact option. The import contact option may provide a user with the ability to import contacts from a file that is saved on the smart watch or to access an external file and download it for import. Additionally, in at least one implementation, the import contact command, or another similar command, can allow a user to sync the smart watch contact application with an online contact service.

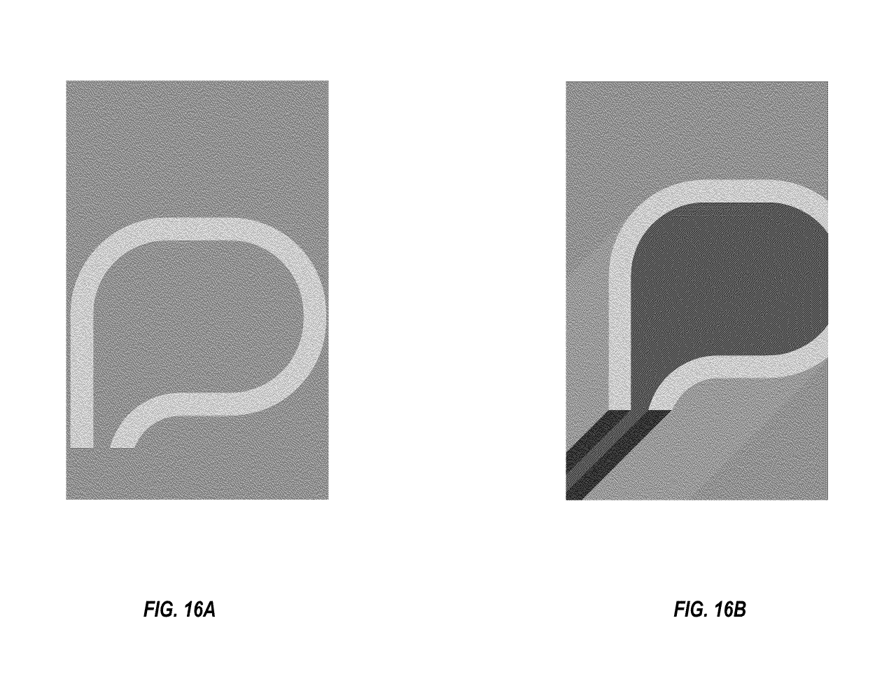

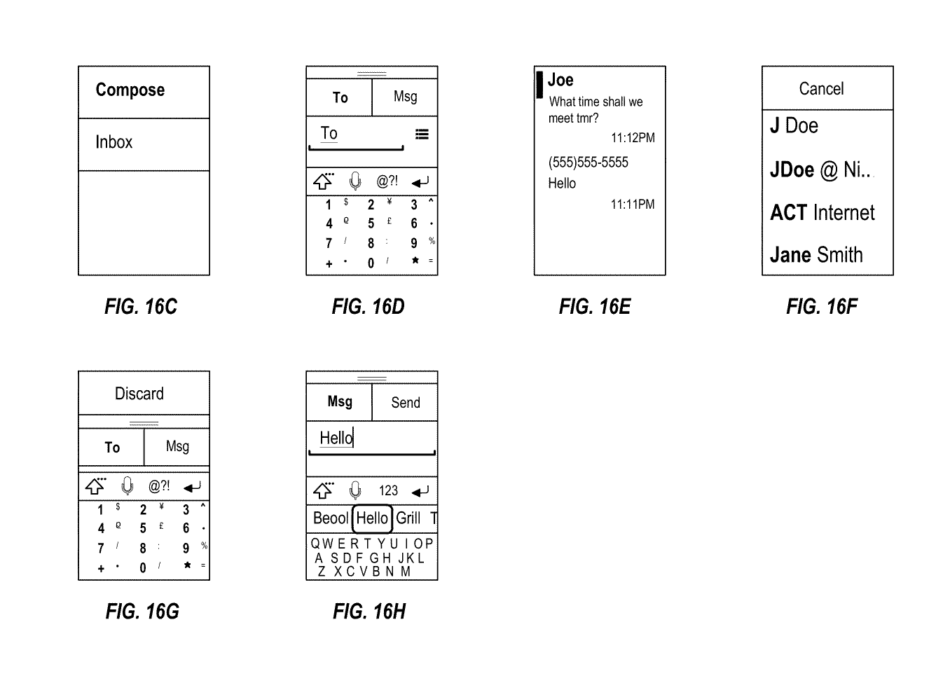

FIGS. 16A-16H depict various implementations of interfaces for a messaging application on a smart watch. In particular, FIGS. 16A and 16B depict icons for a messaging application. In at least one implementation, as a user scrolls through a list of applications the icon of FIG. 16A is initially displayed. Once a user remains on the particular icon for a prolonged period of time (e.g., one second), the icon of FIG. 16A transforms into the icon of FIG. 16B. In at least one implementation, when a user selects the messaging icon of FIG. 16B, a messaging application main menu interface, as depicted in FIG. 16C, is displayed on the smart watch display 110.

The messaging application can provide a user with access to SMS texting, email, or other messaging systems. Additionally, a user can compose and send messages using either an on-screen keyboard or through vocal commands. FIG. 16D depicts an interface for addressing a message to a particular contact or other individual. When selecting an individual to send the message to a user may select an individual from a list of contacts.

FIG. 16E depicts an implementation of an interface for accessing messages within the messaging application. In particular, FIG. 16E depicts various received messages that are displayed all on the smart watch display 110. In at least one implementation, the interface of FIG. 16E only depicts a portion or a summary of each message. A user may be required to select a particular message in order to view the entire content. This may be particularly useful for long messages that may possibly extend beyond the length of the screen. In such a case, the user can scroll the length of the message in a dedicated interface.

FIG. 16F depicts an implementation of an interface for sending a message to a particular contact. In particular, a contact can be selected from within the messaging application. Once selected, the contact's information can automatically be added to a message.

Additionally, FIG. 16G depicts an interface for discarding an unwanted message. For example, a user may begin to draft a message and then decide she no longer desires to send it. By selecting the discard option, the message is easily deleted and removed from the device.

FIG. 16H depicts a message composing interface. For example, a message comprising the word “hello” is depicted. In at least one implementation, the keyboard within the smart watch interfaces utilizes predictive texting. As the user taps various areas of the keyboard, the smart watch predicts the word that the user is attempting to type. For instance, in FIG. 16H the word “hello” is suggested immediately above the keyboard. One will appreciate the difficulty placing a usable full keyboard on a small screen smart watch interface. Implementations of the present invention address this difficulty through the use of predictive type. With predictive typing, a user can accidently press the wrong letter and still be provided with the correct, desired word.

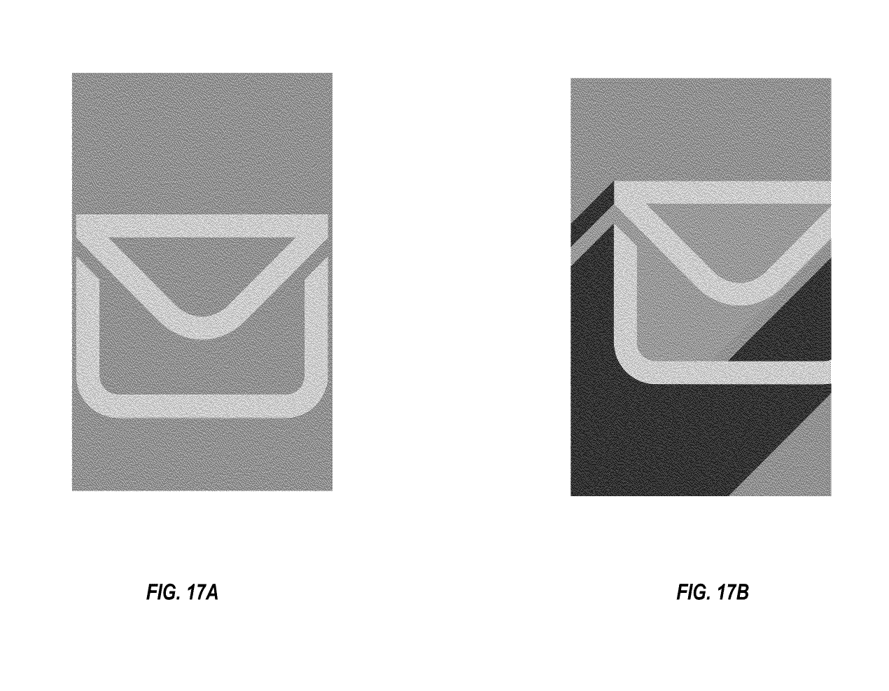

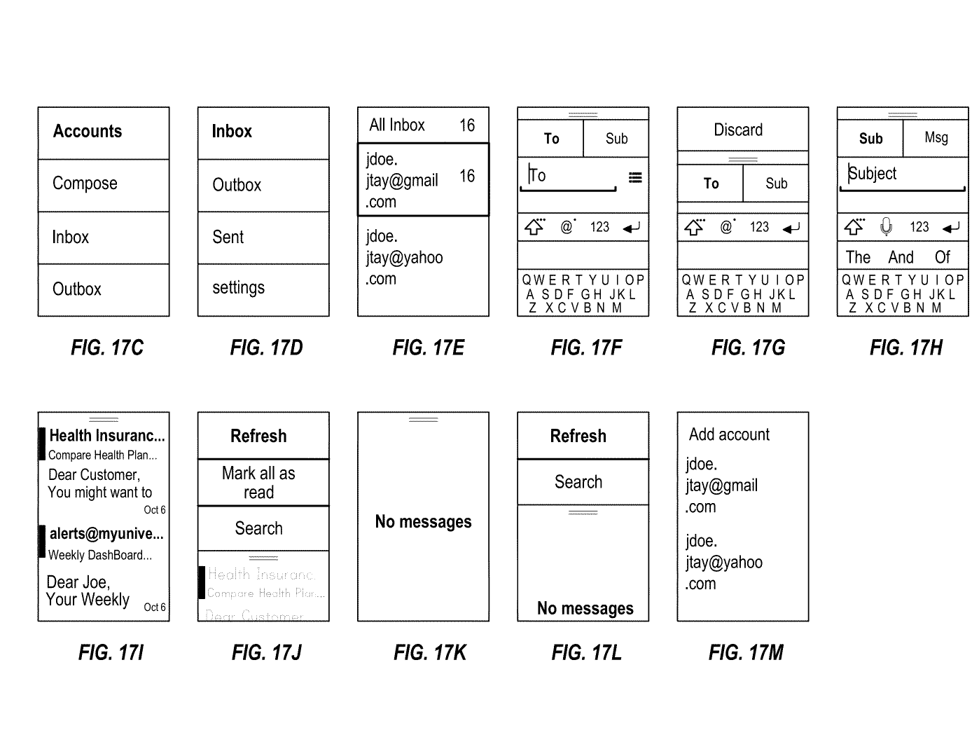

FIGS. 17A-17M depict various implementations of email user interfaces for an email application on a smart watch. In particular, FIGS. 17A and 17B depict icons for an email application. In at least one implementation, as a user scrolls through a list of applications the icon of FIG. 17A is initially displayed. Once a user remains on the particular icon for a prolonged period of time (e.g., one second), the icon of FIG. 17A transforms into the icon of FIG. 17B. FIGS. 17A and 17B depict an email application icon that is selectable for accessing a main menu interface as depicted in FIG. 17C and FIG. 17D. In at least one implementation, the main menu interfaces of FIGS. 17C and 17D comprise a single scrollable menu. In particular, a user can scroll from the menu options shown in FIG. 17C downward to the options shown in FIG. 17D.

FIG. 17E depicts an implementation of a user interface for an inbox selection screen. In particular, two different email accounts are depicted as being selectable as inboxes within the interface of FIG. 17E. In at least one implementation, a user can access both email inboxes at the same time within a single user interface, or the user can access the inboxes individually within an interface. As such, a user is provided control over what emails are displayed within an interface of the smart watch.

FIGS. 17F, 17G, and 17H depict various implementations of composition interfaces within an email application for a smart watch. In particular, FIG. 17F depicts an implementation of an interface for addressing an email, FIG. 17G depicts an implementation of an interface for discarding an email, and FIG. 17H depicts an implementation of an interface for composing a subject of an email. Each of these interfaces can be accessible through an on-screen keyboard, through vocal commands, or through importing a partially or completely finished email from an external source.

FIGS. 17I, 17J, 17K, and 17L depict various interfaces for accessing and reading email. For example, in FIG. 17I an inbox interface is displayed, which depicts to a user various emails that are currently within the inbox of an email account. In at least one implementation, the email inbox interface may comprise various features that indicate whether email has been previously read, whether an email is high priority, or whether an email is otherwise categorized. Similar to the messaging application interface, a user can access the entirety of an email by selecting the email within the interface of FIG. 17I.

Additionally, FIG. 17J depicts an implementation of an email application inbox displaying an action item menu. In various implementations, applications within the smart watch may comprise action item menus. An action item menu may be accessible by swiping from a top of the display and sliding a finger (or other contact) down the screen. In at least one implementation, an interface can comprise a visual indication that an action item menu is available. For example, the interface of FIG. 17I comprises two horizontal parallel lines at the top of the interface. The presence of the two horizontal parallel lines may indicate that an action item menu is available within the present user interface.

An action item menu can provide a user with various commands actions that can be performed within the user interface that is currently displayed on the smart watch. For example, FIG. 17I displays an action item menu that comprises a refresh command, a mark all as read command, and a search command. In at least one implementation, contacting the screen above any of these commands causes the commands to launch. For example, activating the refresh command may cause the smart watch to query one or more email servers to determine if additional email is available.

In at least one implementation, the action item menu is also context sensitive. For example, FIG. 17K comprises an inbox without any messages. In this case, the action item menu, displayed in FIG. 17L, does not comprise a “mark all as read option” because there are no messages to mark.

FIG. 17M depicts a simple interface for adding or removing an email account from an email application on the smart watch. In particular, FIG. 17M depicts two email accounts that are currently active within the smart watch. An “add account” option is available and selectable to enable a user to add in new and or different email accounts to the smart watch. An account can be added to the smart watch through the use of either an on-screen keyboard or vocal commands.

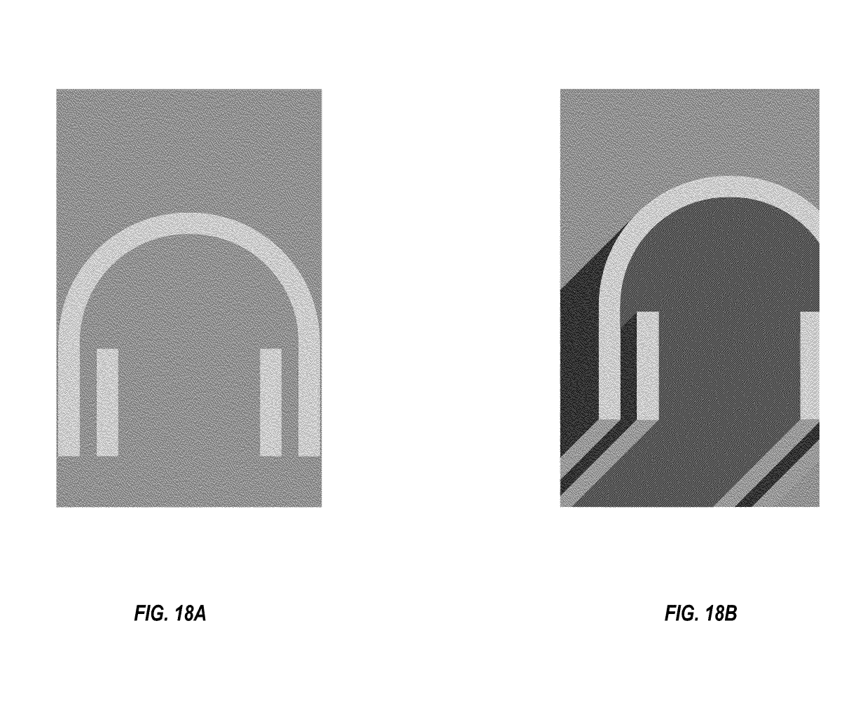

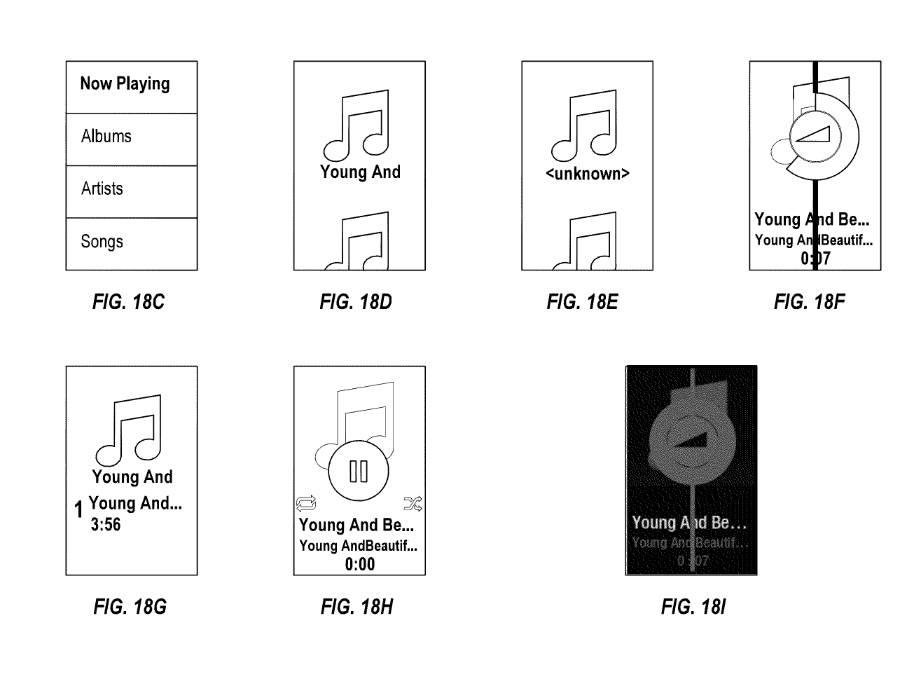

FIGS. 18A-18G depict various implementations of interfaces for a smart watch music application. In particular, FIGS. 18A and 18B depict icons for a music application. In at least one implementation, as a user scrolls through a list of applications the icon of FIG. 18A is initially displayed. Once a user remains on the particular icon for a prolonged period of time (e.g., one second), the icon of FIG. 18A transforms into the icon of FIG. 18B. In at least one implementation, the main menu interface of FIG. 18C is displayed in response to a selection of the music icon a FIG. 18B.

FIGS. 18D-18H depict various implementations of user interfaces for the music application. For example, FIGS. 18D and 18E depict music application interfaces that comprises a song and band name. Similarly, FIG. 18H depicts a music application interface that after a song has been started, and includes a time indication on the screen.

In at least one implementation, the smart watch music application interface comprises a single button to perform the features of play, pause, skip forward, skip backwards, volume up, and volume down. For example, the button of FIG. 18H may be selectable to both play and pause the music within the music application. Additionally, selecting the button and sliding the button upwards on the screen may comprise a command for raising the volume. For example, FIG. 18F depicts an interface when the button has been slid up and the volume has been increased. In at least, one implementation, the button also comprises an indication of the relative volume level. For example, the circle around the button may provide an indication of the current relative volume level. Similarly, sliding the button down can cause the volume to decrease. Additionally, in at least one implementation, sliding the button left may comprise a skip backwards, and sliding the button right may comprise a skip forward.

FIG. 18I depicts an implementation of an interface for a music application where the volume is being increased to a maximum. In particular, the volume button is surrounded by a complete circle, as compared to the circle of FIG. 18F. The complete circle indicates that the maximum volume has been reached.

As such, various implementations of the present invention provide highly efficient interfaces for interacting with media on a smart watch. For example, the single button interface described above provides significant benefits within a smart watch implementation. One will understand the screen space on a smart watch is highly limited. Additionally, it can be easy to make an interface overly cumbersome by including too many distinct buttons within a single screen. Implementations of the present invention overcome these conventional deficiencies by including multiple distinct features within a single button.

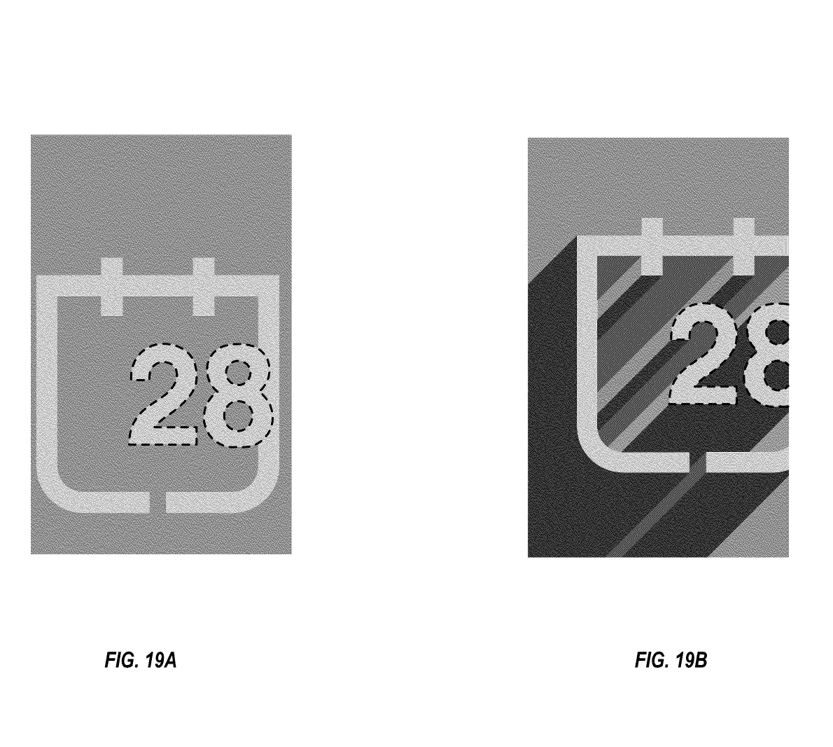

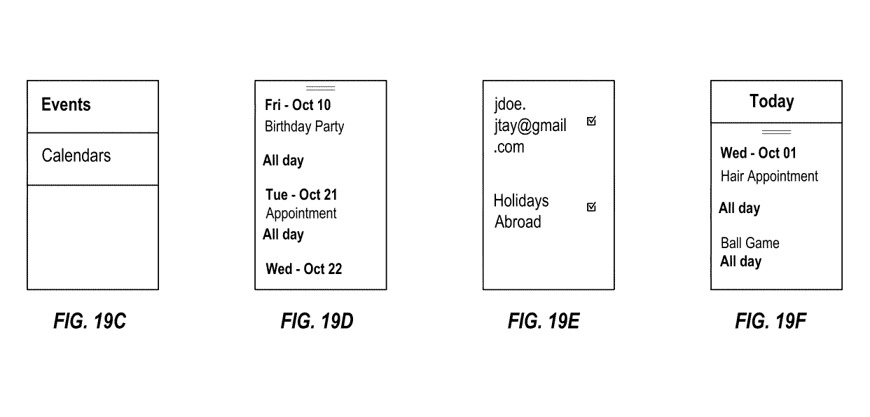

FIGS. 19A-19F depict various implementations of a user interface for a calendar application. In particular, FIGS. 19A and 19B depict icons for a calendar application. In at least one implementation, as a user scrolls through a list of applications the icon of FIG. 19A is initially displayed. Once a user remains on the particular icon for a prolonged period of time (e.g., one second), the icon of FIG. 19A transforms into the icon of FIG. 19B. FIG. 19B depicts a calendar application icon that is selectable by a user to display the calendar application main menu as depicted in FIG. 19C. The calendar main menu of FIG. 19C comprises an events feature and a calendars feature. In alternate implementations, the main menu may comprise different or additional features such as create an event, invite someone to an event, create a reminder, and other conventional electronic calendar features.

FIGS. 19D-19F comprise various implementations of calendar interfaces that display user data. For example, FIG. 19D displays calendar items over a period of several days. Similarly, FIG. 19F depicts a user interface comprising calendar items for the current day. Both of the interfaces in FIG. 19D and FIG. 19F comprise an action item menu as indicated by the bars at the top of the interface. While not explicitly depicted here, the action item menu may comprise commands for creating calendar events, sending invitations to calendar events, deleting calendar events, categorizing calendar events, and other similar calendaring commands.

FIG. 19E depicts an implementation of an interface for subscribing to various calendars. In particular, a user can subscribe to online calendar services, shared calendars, and subscription calendars. In at least one implementation, a user can also share a calendar using a smart watch interface.

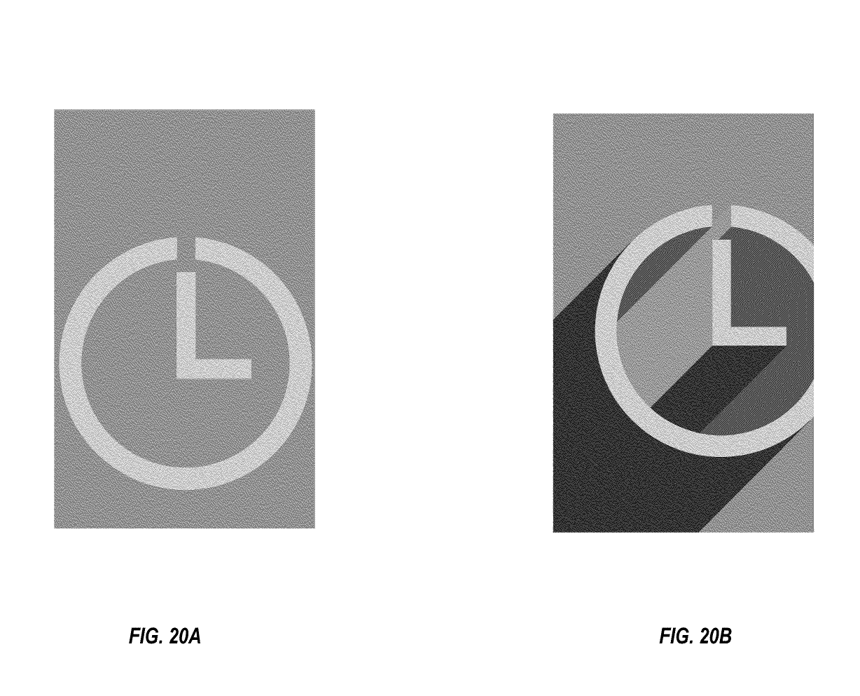

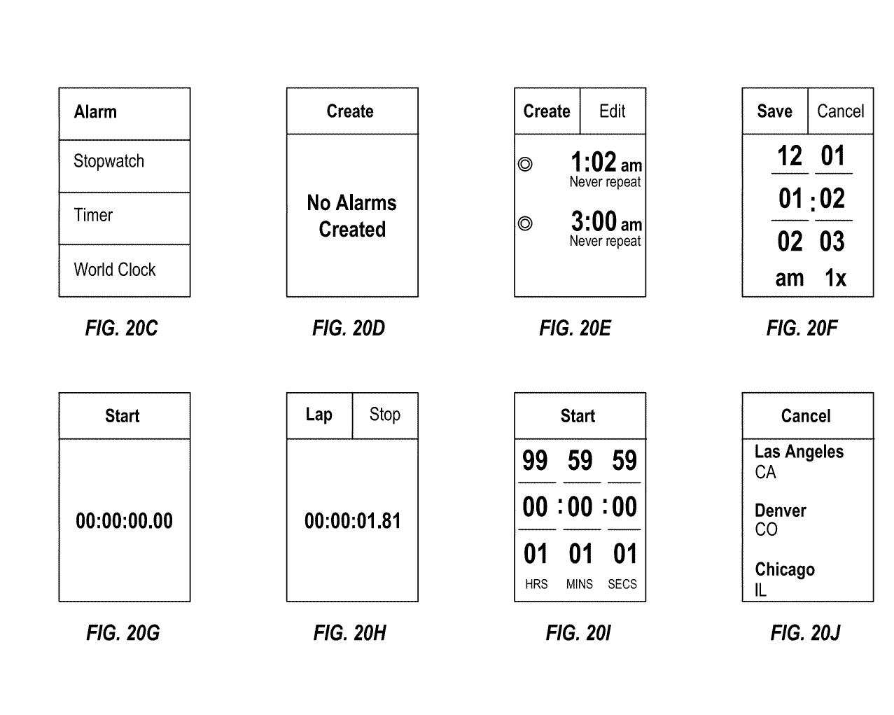

FIGS. 20A-20J depicting various implementations of a clock user interface. In particular, FIGS. 20A and 20B depict icons for a clock application. In at least one implementation, as a user scrolls through a list of applications the icon of FIG. 20A is initially displayed. Once a user remains on the particular icon for a prolonged period of time (e.g., one second), the icon of FIG. 20A transforms into the icon of FIG. 20B. FIG. 20C depicts a clock application main menu. The main menu can comprise options for an alarm interface, a stopwatch interface, a timer interface, and a world clock interface. FIGS. 20D-20J depict various implementations of interfaces for these features.

FIGS. 20D-20F depict implementations for alarm user interfaces. In particular, FIG. 20D displays an alarm interface without any current available alarms, but provides a create option to create alarms. FIG. 20E, on the other hand, displays two previously created alarms. Additionally, FIG. 20E provides options to create further alarms or to edit the currently created alarms. For example, FIG. 20F depicts an implementation of an alarm being created or edited. In at least one implementation, the alarm interface allows a user to create repeating alarms, alarms assigned to specific days, or other conventional alarms.

FIGS. 20G and 20H depict implementations of a stopwatch user interface. FIG. 20G depicts a stopwatch interface comprising a start button and clock display. FIG. 20H depicts a running stopwatch with a lap option and a stop option. Similar, to the stopwatch interface of FIGS. 20G and 20H, FIG. 20I depicts a timer interface. In particular, FIG. 20I depicts a start option and hours, minutes, in seconds setting option. In at least one implementation, a smart watch provides a highly useful form factor for exercise tracking. As such, in at least one implementation, various applications installed on a smart watch can access stopwatch and timer information and provide a user with fitness information.

FIG. 20J depicts a world clock interface. In at least one implementation, a user can access the world clock feature to determine a time at various locations around the world. Additionally, in at least one of mentation, the smart watch automatically updates its time to reflect the correct time based upon the smart watches current geographic location.

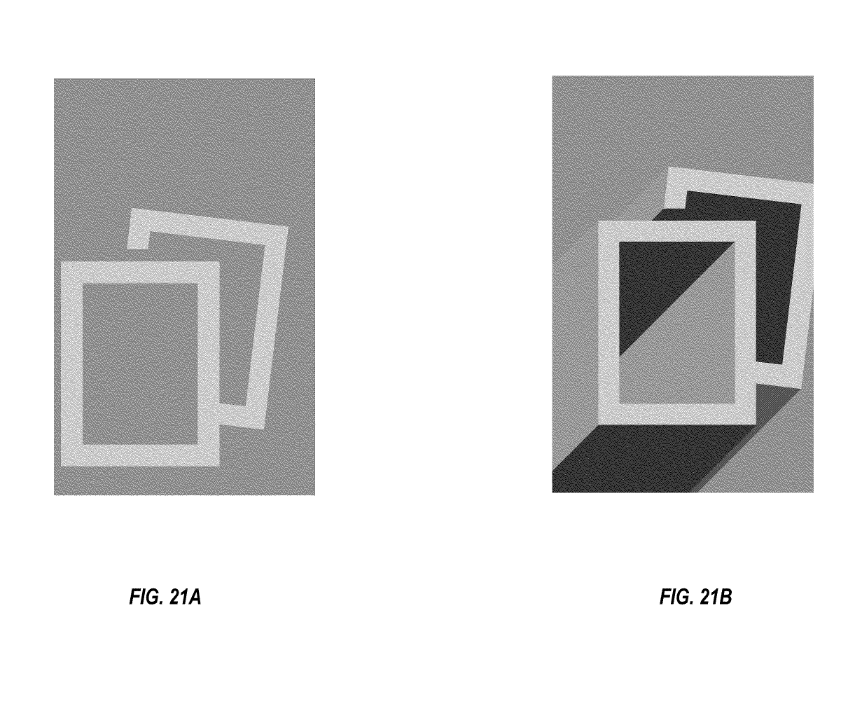

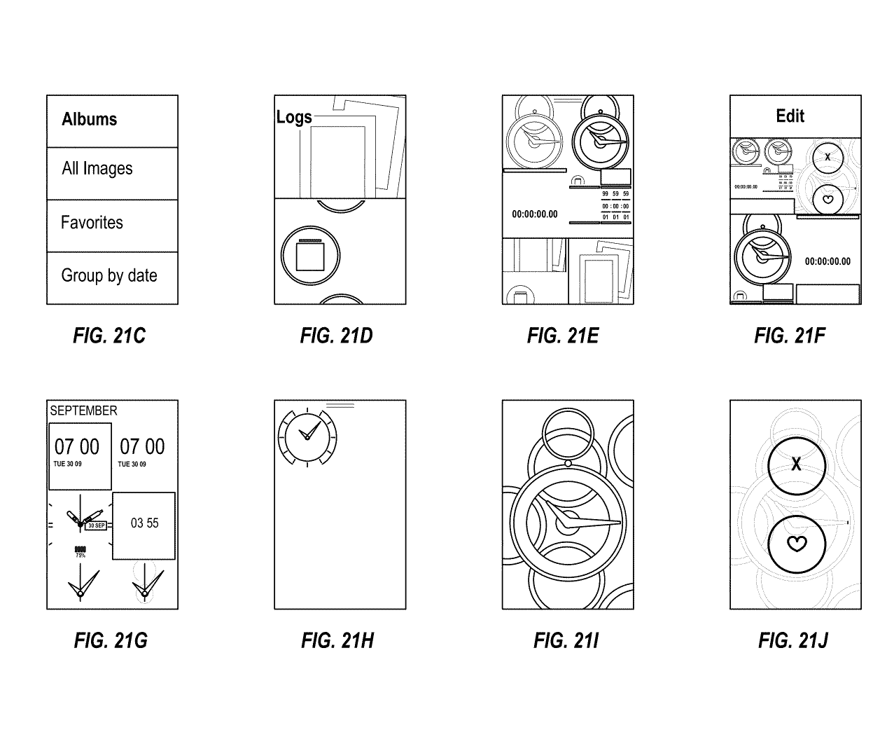

FIGS. 21A-21I depict various implementations of user interfaces for a gallery application. In particular, FIGS. 21A and 21B depict icons for a gallery application. In at least one implementation, as a user scrolls through a list of applications the icon of FIG. 21A is initially displayed. Once a user remains on the particular icon for a prolonged period of time (e.g., one second), the icon of FIG. 21A transforms into the icon of FIG. 21B. FIG. 20C depicts a clock application main menu. FIGS. 21D-21J depict various implementations of interfaces within the gallery application. For example, FIGS. 21D-21J depict various interfaces showing images that are stored in the gallery.

Additionally, FIGS. 21F and 21J depict user interface implementations for editing or otherwise adjusting images within the gallery. For example, FIG. 21F depicts an edit option. In at least one implementation, the edit option allows a user to delete an image, to adjust image characteristics, or to rename image. In at least one implementation, the options within FIG. 21J allow a user to delete an image or to indicate a preference for the image.

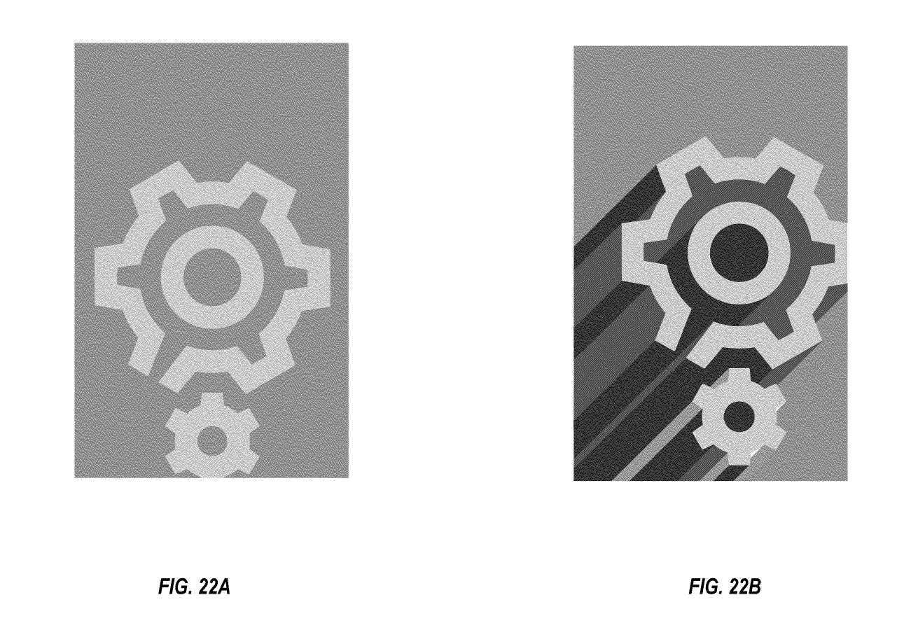

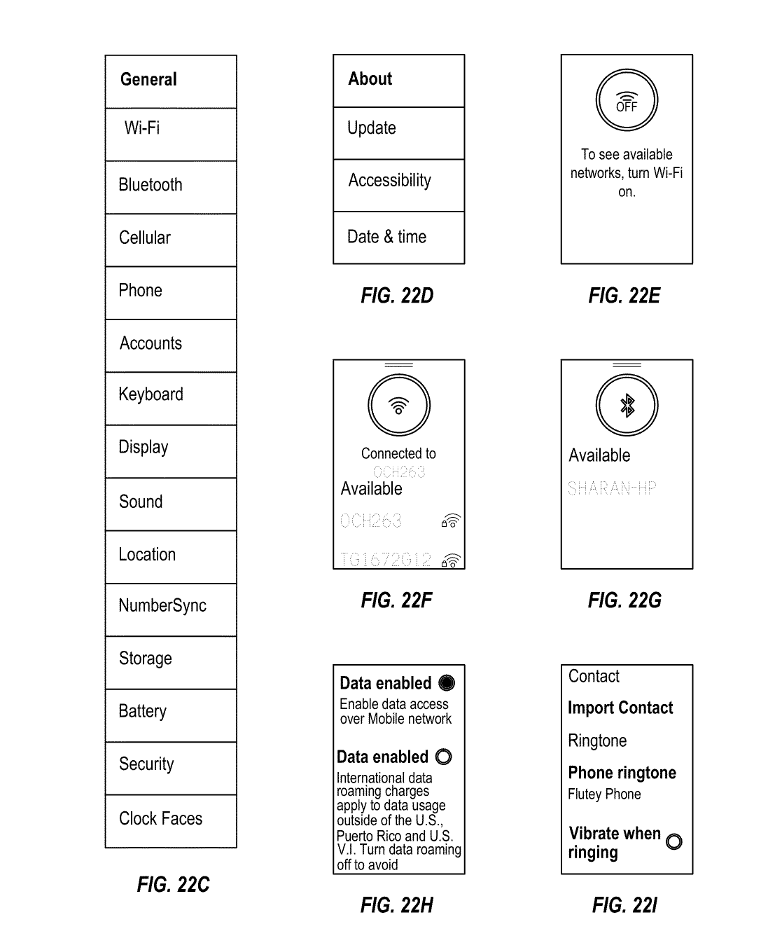

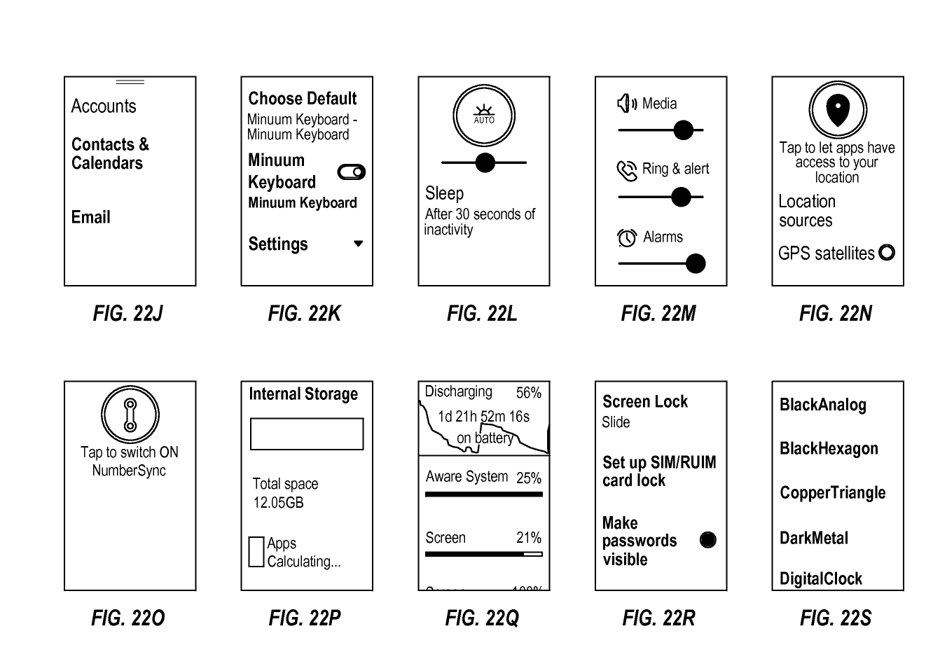

FIGS. 22A-22T depict various implementations of user interfaces for a setting application. In particular, FIGS. 22A and 22B depict icons for a settings application. In at least one implementation, as a user scrolls through a list of applications the icon of FIG. 22A is initially displayed. Once a user remains on the particular icon for a prolonged period of time (e.g., one second), the icon of FIG. 22A transforms into the icon of FIG. 22B. FIG. 20C depicts a clock application main menu. Additionally, FIG. 22C depicts a main menu within the setting application. The depicted main menu comprises options for a general interface, a Wi-Fi interface, a Bluetooth interface, a cellular interface, a phone interface, an accounts interface, a keyboard interface, a display interface, a sound interface, a location interface, a number sync interface, a storage interface, a battery interface, a security interface, a clock faces interface, and various other additional interface.

FIGS. 22D-22S show various implementations of user interfaces within the setting application. For example, FIG. 22D depicts a general setting user interface. The general setting user interface can comprise an about feature, an update feature, an accessibility feature, and a date & time feature. In at least one implementation, these features provide general control over the settings of the smart watch device.

FIGS. 22E-22H comprise implementations of user interfaces for various communication standards. For example, FIGS. 22E and 22F comprise user interfaces for controlling Wi-Fi. FIG. 22G, on the other hand, comprises a user interface for controlling Bluetooth. Similarly, FIG. 22H displays a user interface for controlling cellular connectivity.

FIGS. 22I-22K comprise various implementations of user interfaces for controlling the settings relating to various applications within the smart watch. For example, FIG. 22I comprises an implementation of a user interface for adjusting the settings relating to the phone within the Smart watch. For example, a user can import contacts, change the ring tone, or adjust the vibration of the phone. FIG. 22J comprises a user interface for associating various accounts with the smart watch. For instance, a user can associate an email account, a calendar account, or a contacts account with the smart watch. FIG. 22K depicts a user interface for a keyboard setting. Within the interface of FIG. 22K, a user can set various features relating to on-screen keyboards.

FIGS. 22L-22N depict various user interfaces for adjusting the settings of hardware features of the smart watch. For example, within the user interface of FIG. 22L, a user can adjust the sleep feature of the smart watch. Additionally, in the user interface of FIG. 22M, a user can adjust various sound settings for the smart watch. In addition, in the user interface of FIG. 22N, a user can adjust various GPS settings for the smart watch.

Various other user interfaces can allow a user to set specific features within the watch. For example, FIGS. 22O, 22R, 22S, and other possible user interfaces can allow users to set up such functions as twinning, screen locking, and selecting a particular displayed clock face.

In addition to allowing a user to adjust settings within the smart watch, in at least one implementation, the user interfaces can also provide a user with information regarding the smart watch. For example, FIG. 22P depicts a user interface showing the storage statistics for the smart watch. In particular, an indication of total storage, available storage, and app storage can be provided to a user. Similarly, FIG. 22Q displays an interface for battery information. The user interface of FIG. 22Q may display a projected battery life, the current charge level, and other similar battery related data points.

One will understand, in light of the above disclosure, that a novel smart watch 100 as disclosed provides for a variety of different use cases. For example, the smart watch 100 may be configured to receive and place voice and/or video calls over a cellular network using cellular hardware, over a Wi-Fi network using Wi-Fi hardware, etc. In some embodiments, the smart watch 100 can play audio of a conversation over an integrated speaker, while in other embodiments the smart watch 100 plays audio of a conversation over an external speaker (e.g., via a headphone jack or Bluetooth). Similarly, in some embodiments, the smart watch 100 records audio of a conversation with an integrated microphone, while in other embodiments the smart watch 100 records audio of a conversation with an external microphone (e.g., via a headphone jack or Bluetooth). One or more cameras may capture still or video images of the wearer/user.

Additionally, as disclosed above, the smart watch 100 can comprise electronic communications functionality (e.g., SMS, MMS, e-mail). For example, the smart watch 100 can include voice control functionality. For instance, the wearer/user may initiate the composition of an email by saying, “compose e-mail to Richard Curtis,” or “Reply.” Any other voice control situations/functions are also possible, such as voice controls to initiate music playback, to initiate voice communications, to receive status (e.g., watch status), or to receive any other information (e.g., weather, movies, directions, etc.). For example, a wearer/user may be able to fetch directions home by saying, “What's the fastest way home?”

Additionally, the smart watch 100 may be configured to automatically push information to a wearer/user based on context (e.g., physical location, time of day, physical (biological) condition of the wearer/user, etc.). For example, the smart watch 100 may be able to detect that the wearer/user is in a subway (and detect the wearer/user's location in the subway), and push relevant information (e.g., time to next stop, further directions, weather at destination, receipt for fare payment, etc.) to the wearer/user. The smart watch 100 may be able to detect the wearer/user's location based on GPS, WiFi networks, ambient noise, scanning of NFC, notification of fare payment, etc.

In at least one implementation, the smart watch 100 may be able to push recommendations and/or advertising to a wearer/user based on the wearer/user's location. For example, the smart watch 100 can push a restaurant recommendation to the wearer/user based on the wearer/user's location. Recommendations may come based on paid advertising, social connections, time of day, etc.

Further, in at least one implementation, the smart watch 100 may be configured to operate within a home automation environment. For example, the smart watch 100 may communicate with home automation components locally (e.g., Bluetooth, NFC, WiFi) or remotely (e.g., over the Internet using a WiFi or a cellular connection). For instance, in at least one implementation, the smart watch 100 may be usable with a smart door lock to gain access to a physical location (e.g., a residence, a business, etc.). For example, a user may scan a NFC tag on a door that the user desires to access, and then enter a lock code on the display 110 (e.g., by changing the length of each of a plurality of bars) to gain access.

Additionally, the smart watch 100 may include fitness functionality. For example, the smart watch 100 may track workout and biological data, such as speed, pace, elevation, heart rate, cadence, strokes, laps, calories burned and/or burn rate, etc. The smart watch 100 may gather such workout and biological data using internal sensors, and/or using external sensors (e.g., sensors that interface/communicate with the smart watch 100 using Bluetooth or ANT+). As such, the smart watch 100 can function as a fitness computer/monitor to track a variety of physical activity (e.g., running, swimming, cycling, hiking, etc.).

In some embodiments, the smart watch 100 is configured to function as a general health monitor that can track biological information throughout the day and over time. For example, the smart watch 100 can track a user's activity level, steps, heart rate, etc. on an occasional or continuous basis. In addition, the smart watch 100 can receive and track other supplied information, such as calories consumed, weight, body fat percentage, etc. As such, the smart watch 100 can function as a personal health trainer/assistant.

Additionally, the smart watch 100 can be configured to receive courses/challenges from other users, such as friends on a social network. The smart watch 100 can then function as a virtual trainer/partner during a workout, to show pace, time ahead/behind the other user, etc. to help encourage and motivate a user during a workout. The smart watch 100 can also be configured to record a wearer/user's workout, and to send challenges to other users based on the recorded workout.

The smart watch 100 can also be configured as a personal media device, to play back locally- or remotely-stored media (e.g., music and videos). Media playback may be controllable via voice command (e.g., “play music,” “play workout mix,” “play Asaf Avidan,” etc.), in addition to other control functions (e.g., menus, buttons).

The smart watch 100 can be configured to interface with a television or other home entertainment system, such as via Infrared, Bluetooth, Wifi, etc. As such, the smart watch 100 may be usable to view available programming, to initiate playback of programming, and otherwise control content at a home entertainment system. In some embodiments (as depicted), the smart watch 100 interfaces with a media provider (e.g., Netflix, Hulu).

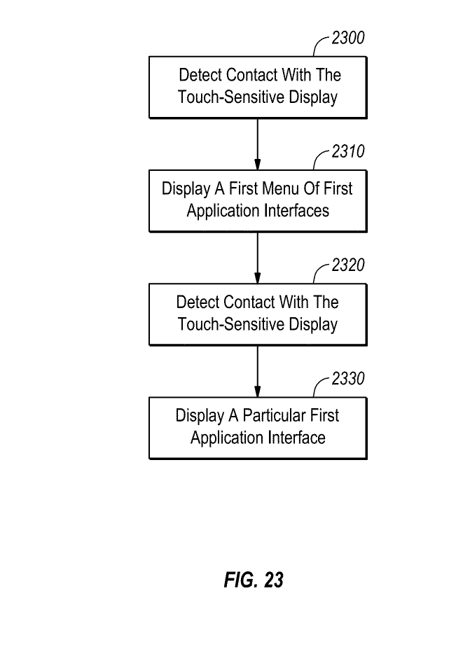

Accordingly, FIGS. 1-22S and the corresponding text illustrate or otherwise describe one or more methods, systems, and/or instructions stored on a storage medium for interacting with a smart watch. One will appreciate that implementations of the present invention can also be described in terms of methods comprising one or more acts for accomplishing a particular result. For example, FIG. 23 and the corresponding text illustrate a flowchart of a sequence of acts in a method for interacting with a user on a smart watch.

For example, FIG. 23 illustrates that a flow chart for an implementation of a method for controlling a smart watch can comprise an act 2300 of detecting contact with the touch-sensitive display. Act 2300 includes detecting contact with the touch-sensitive display while the smart watch is displaying a first application interface associated with a first application. The detected contact can originate in a first area of the touch-sensitive display and move in a first direction. For example, in FIGS. 4 and 5 a finger is detected contacting the touch-sensitive display of the smart watch on the right side and moving towards the left side.

FIG. 23 also shows that the method can comprise an act 2310 of displaying a first menu of first application interfaces. Act 2310 includes displaying a first menu of first application interfaces available within the first application. The first application interfaces can comprise a set of unique user interfaces that are accessible within the first application. For example, in FIGS. 17B and 17C, a first menu for an email application is displayed. The first menu comprises options for an accounts interface, a compose interface, an inbox interface, an outbox interface, a sent interface, and a settings interface.

Additionally, FIG. 23 shows that the method can comprise an act 2320 of detecting contact with the touch-sensitive display. Act 2320 includes detecting contact on an indication of a particular first application interface from within the first menu. For example, a user can contact with her finder any of the interfaces available within the first menu of FIGS. 17B and 17C.

Further, FIG. 23 shows that the method can comprise an act 2330 of displaying a particular first application interface. Act 2330 includes displaying, on the touch sensitive display, the particular first application interface. For example, a touch-sensitive display can display the user interface of FIG. 17L in response to a detected contact of the “Accounts” interface of FIG. 17B.

Accordingly, the embodiments disclosed herein provide for a wearable computing device in the form of a smart watch 100 that can be used for a rich variety of functions, which can use a variety of sensors to gather information about a user/wearer and the context of the watch, and that can provide a variety of output on the watch and associated devices.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for controlling a smart watch with a touch-sensitive display, the method comprising:
detecting contact with the touch-sensitive display while the smart watch is displaying a first application interface associated with a first application, wherein the detected contact originates in a first area of the touch-sensitive display and is moving in a first direction;
displaying a first menu of first application interfaces available within the first application, wherein the first application interfaces comprise a set of unique user interfaces that are accessible within the first application;
detecting contact on an indication of a particular first application interface from within the first menu; and
displaying, on the touch sensitive display, the particular first application interface.

2. The method as recited in claim 1, wherein the first menu of first application interfaces comprises a vertically aligned series of virtual buttons, wherein each virtual button comprises text describing a first application interface associated with the respective button.

3. The method as recited in claim 1, wherein the first application is a distinct application running on an operating system associated with the smart watch.

4. The method as recited in claim 1, further comprising:
detecting contact with the touch-sensitive display while the smart watch is displaying the particular first application interface, wherein the detected contact originates in a second area of the touch-sensitive display and is moving in a second direction;
displaying a second menu comprising one or more commands available within the particular first application interface, wherein the one or more commands act upon items displayed within the particular first application interface;
detecting contact on a particular command from the one or more command within the second menu; and
performing the action associated with the particular command.

5. The method as recited in claim 4, wherein the first direction and the second direction are substantially opposite to each other.

6. The method as recited in claim 4, wherein the first direction and the second direction are substantially perpendicular to each other.

7. The method as recited in claim 4, wherein:
the first area of the touch-sensitive display comprises the left side of the touch-sensitive display; and
the first direction comprises a sliding movement from the left side of the touch-sensitive display towards the right side of the touch-sensitive display.

8. The method as recited in claim 7, wherein:
the second area of the touch-sensitive display comprises the top side of the touch-sensitive display; and
the second direction comprises a sliding movement from the top side of the touch-sensitive display towards the bottom side of the touch-sensitive display.

9. The method as recited in claim 7, wherein:
the second area of the touch-sensitive display comprises the right side of the touch-sensitive display; and
the second direction comprises a sliding movement from the right side of the touch-sensitive display towards the left side of the touch-sensitive display.

10. The method as recited in claim 4, wherein a menu indicator indicates the availability of a second menu before the second menu is accessed.

11. The method as recited in claim 10, wherein the menu indicator comprises two parallel bars positioned at the top of the touch-sensitive display.

12. The method as recited in claim 1, wherein displaying the first menu of first application interfaces comprises:
in response to the detected contact moving in the first direction, continuously moving the first menu along with the contact.

13. A smart watch system, comprising:
one or more processors;
system memory;
a watchband extending from a first side of a touch-sensitive display to a second side of the touch sensitive display, wherein the watchband comprises a clasp mechanism that allows the watchband to be placed around a wrist; and
the touch-sensitive display, wherein the touch-sensitive display is configured to:
detect contact with the touch-sensitive display while the smart watch is displaying a first application interface associated with a first application, wherein the detected contact originates on a left side of the touch-sensitive display and is moving towards the right side of the touch-sensitive display;
display a first menu of first application interfaces available within the first application, wherein the first application interfaces comprise a set of unique user interfaces that are accessible within the first application;
detect contact, within the first menu of first application interfaces, on a visual indication representing a particular first application interface; and
display, on the touch sensitive display, the particular first application interface.

14. The system as recited in claim 13, wherein the first application interface comprises an interface for a smart watch email application.

15. The system as recited in claim 14, wherein the set of unique user interfaces within the first menu comprise an interface for an email inbox and an interface for email composition.

16. The system as recited in claim 13, wherein the touch-sensitive display is further configured to:
detect contact with the touch-sensitive display while the smart watch is displaying the particular first application interface, wherein the detected contact originates at the top of the touch-sensitive display and is moving towards the bottom of the touch-sensitive display;
display a second menu comprising one or more commands available within the particular first application interface, wherein the one or more commands act upon items displayed within the particular first application interface;
detect contact on a particular command from the one or more commands within the second menu; and
perform the action associated with the particular command.

17. The system as recited in claim 16, wherein the particular first application interface comprises an interface for an inbox within a smart watch email application.

18. The system as recited in claim 17, wherein the one or more commands comprise a refresh command.

19. The system as recited in claim 13, wherein the touch-sensitive display is further configured to:
detecting contact with the touch-sensitive display while the smart watch is displaying a first application interface associated with a first application, wherein the detected contact originates in a first area of the touch-sensitive display and is moving in a first direction;
displaying a first menu of first application interfaces available within the first application, wherein the first application interfaces comprise a set of unique user interfaces that are accessible within the first application;
detecting contact on an indication of a particular first application interface from within the first menu; and
displaying, on the touch sensitive display, the particular first application interface.

20. A computer program product comprising one or more computer storage media having stored thereon computer-executable instructions that, when executed at a processor, cause the computer system to perform a method controlling a smart watch with a touch-sensitive display, the method comprising:
detecting contact with the touch-sensitive display while the smart watch is displaying a first application interface associated with a first application, wherein the detected contact originates in a first area of the touch-sensitive display and is moving in a first direction;
displaying a first menu of first application interfaces available within the first application, wherein the first application interfaces comprise a set of unique user interfaces that are accessible within the first application;
detecting contact on an indication of a particular first application interface from within the first menu; and
displaying, on the touch sensitive display, the particular first application interface.
